(19) United States
(12) Patent Application Publication
(10) Pub. No.: US 2011/0148661 A1
(43) Pub. Date: Jun. 23, 2011

(54) GUIDING DEVICE

(76) Inventors: Shinichi Shikii, Nara (JP); Shinichi Kodawaki, Hyogo (JP); Kazuhisa Yamamoto, Osaka (JP); Hiroyuki Furuya, Osaka (JP); Tatsuo Itoh, Osaka (JP)

(21) Appl. No.: 13/002,134

(22) PCT Filed: Jun. 30, 2009
(86) PCT No.: PCT/JP2009/003022

§ 371 Date: Jan. 10, 2011

(30) Foreign Application Priority Data
Jul. 2, 2008 (JP) 2008-172976

(51) Int. Cl. G08G 1/095; H01S 3/00; H05B 37/02; G08G 5/06

(52) U.S. Cl. 340/907; 362/553; 315/307; 340/944

(57) ABSTRACT

A guiding device includes: a laser light source that emits a laser beam; and a linear guiding portion that propagates the laser beam and is extended in the guiding direction on a road surface on which a mobile body moves. The linear guiding portion is provided with a function of radiating the laser beam in the guiding direction from the surface where linear guiding portion extends, while propagating the laser beam, and guiding the mobile body by light.

### TECHNICAL FIELD

The present invention relates to a guiding device that adequately guides a mobile body such as a human, a vehicle, and an airplane.

### BACKGROUND ART

Road display devices are needed that allow, for example, a driver to drive safely a vehicle such as an automobile in the nighttime or in dark locations, or to park the vehicle safely in a parking lot in a dark sites.

A “Self-Emitting Road Rivet” that enables a vehicle driver to see clearly a horizontal light-emitting surface from a distance and also to enable an approaching vehicle driver or pedestrian to see clearly an upward light-emitting surface has been suggested as such a road display device (see, for example, Patent Document 1). Such a road display device is provided with an accommodation portion in an adequate installation side on a road, a light-emitting diode is disposed in the accommodation portion, the light emitted from the light-emitting diode is guided on the ground by fibers and the arrangement method and cut specifications of the fibers make it possible to obtain the road display device with good visibility.

Further, it has also been suggested to use such fibers and laser to perform road display in heavy-snow regions (see, for example, Patent Document 2). With such a road display device, by using the linearity of the laser beam emitted from a laser, it is possible to recognize the display contents of the road display through snow or rain even in the zones with snow accumulation.

Block products for roads have also been suggested that have self-emitting devices embedded and integrated therewith and facilitate recognition and guidance for vehicles and people in the nighttime by disposing fiber cables (see, for example, Patent Document 3). A variety of display methods can be used with such road display devices, and all-weather solar power sources have been used therewith. As a result, the power source can be repeatedly charged and discharged regardless of the installation site and a maintenance-free product with a long service life is obtained.

However, the above-described configurations of the conventional road display devices require a light source to be disposed close to the irradiation site. As a result, when the laser source is used outdoors, high-level waterproofing is required. In particular, when long-distance irradiation is performed, cost is increased. Another problem is that when the laser light source should be replaced, for example, at the end of service life thereof, large-scale road work is required, and the work takes a long time and requires a high cost.

Patent Document 1: Japanese Laid-Open Patent Publication No. 7-305313

Patent Document 2: Japanese Laid-Open Patent Publication No. 2002-38433

Patent Document 3: Japanese Utility Model Registration No. 3036936

### DISCLOSURE OF THE INVENTION

It is an object of the present invention to provide a guiding device that excels in visibility, while being simple in construction and installation at a low cost.

A guiding device according to one aspect of the present invention guides a mobile body by light and includes a laser light source that emits a laser beam, and a linear guiding portion that propagates the laser beam and is extended in a guiding direction on a road surface on which the mobile body travels, wherein the linear guiding portion irradiates the laser beam with directivity in the guiding direction from a surface where the linear guiding portion extends, while propagating the laser beam.

With the above-described configuration, by extending the linear guiding portion connected to the laser light source, it is possible to guide by light easily and within a wide range. As a result, it is possible to realize a low-cost guiding device that is simple in structure and installation and easy to maintain. Further, the guiding device can irradiate a laser beam with good directivity along the guiding direction. As a result, it is possible to realize a guiding device of excellent visibility that can be easily seen by a driver of a mobile body.

Other objects, features, and advantages of the present invention can be fully understood from the description presented below. The merits of the invention will be apparent from the following explanation given with reference to the appended drawings.

### BRIEF DESCRIPTION OF THE DRAWINGS

FIG. 1 is an explanatory drawing illustrating a schematic configuration of a guiding device of one embodiment of the present invention.

FIG. 2 is an explanatory drawing illustrating a schematic configuration of a guiding device of one embodiment of the present invention.

FIG. 3A is a cross-sectional view illustrating an example of a schematic configuration of a fiber used in guiding device of one embodiment of the present invention; FIG. 3B is a cross-sectional view illustrating an example of a schematic configuration of a fiber used in the guiding device of one embodiment of the present invention; FIG. 3C is a cross-sectional view illustrating an example of a schematic configuration of a fiber used in the guiding device of one embodiment of the present invention; and FIG. 3D is a cross-sectional view illustrating an example of a schematic configuration of a fiber used in the guiding device of one embodiment of the present invention.

FIG. 4A is a schematic diagram illustrating a configuration example of an optical system used in the guiding device of one embodiment of the present invention. FIG. 4B is a schematic diagram illustrating another configuration example of an optical system used in the guiding device of one embodiment of the present invention.

FIG. 5 is a cross-sectional view illustrating a configuration of another fiber used in the guiding device of one embodiment of the present invention.

FIG. 6 is a plan view illustrating a configuration of another fiber used in the guiding device of one embodiment of the present invention.

FIG. 7A is an explanatory drawing illustrating a schematic configuration of another fiber used in the guiding device of one embodiment of the present invention. FIG. 7B is a cross-sectional view taken along the 7B-7B line in the fiber shown in FIG. 7A.

FIG. 8 is a cross-sectional view illustrating a schematic configuration of another fiber used in the guiding device of one embodiment of the present invention.

FIG. 9A is an explanatory drawing illustrating yet another fiber used in the guiding device of one embodiment of the present invention. FIG. 9B is an explanatory drawing illustrating yet another fiber used in the guiding device of one embodiment of the present invention. FIG. 9C is an explanatory drawing illustrating yet another fiber used in the guiding device of one embodiment of the present invention.

FIG. 10A is an explanatory drawing illustrating schematically the configuration of yet another fiber used in the guiding device of one embodiment of the present invention. FIG. 10B is cross-sectional view illustrating schematically the configuration of yet another fiber used in the guiding device of one embodiment of the present invention. FIG. 10C is a perspective view illustrating schematically the configuration of yet another fiber used in the guiding device of one embodiment of the present invention.

FIG. 11A is an explanatory drawing illustrating schematically the configuration of yet another fiber used in the guiding device of one embodiment of the present invention. FIG. 11B is an explanatory drawing illustrating schematically the configuration of yet another fiber used in the guiding device of one embodiment of the present invention.

FIG. 12 is an explanatory drawing illustrating schematic configuration of a guiding device of another embodiment of the present invention.

FIG. 13 is an explanatory drawing representing an example in which a guiding linear portion of the guiding device of another embodiment of the present invention is disposed along a road surface of a highway or a general road.

FIG. 14 is an explanatory drawing representing an example in which a guiding linear portion of the guiding device of another embodiment of the present invention is disposed along a curved road surface of a highway or a general road.

FIG. 15 is an explanatory drawing representing an example in which a guiding linear portion of the guiding device of another embodiment of the present invention is disposed along a road surface inside a tunnel.

FIG. 16A is an explanatory drawing illustrating a schematic configuration diagram of another guiding device of another embodiment of the present invention. FIG. 16B is an explanatory drawing illustrating a schematic configuration diagram taken along the 16B-16B line in another guiding device of another embodiment of the present invention.

FIG. 17A is an explanatory drawing illustrating a schematic configuration diagram of another guiding device of another embodiment of the present invention. FIG. 17B is a cross-sectional view taken along the 17B-17B line in the guide shown in FIG. 17A.

FIG. 18A is a top view illustrating a schematic configuration diagram of a guiding device of yet another embodiment of the present invention. FIG. 18B is an explanatory drawing illustrating a schematic configuration diagram of the guiding device in FIG. 18A.

FIG. 19 is an explanatory drawing illustrating a schematic configuration of a guiding device of yet another embodiment of the present invention.

FIG. 20A is an explanatory drawing illustrating a schematic configuration of yet another guiding device in accordance with the present invention. FIG. 20B is an explanatory drawing illustrating a schematic configuration of a joining portion of the guiding device shown in FIG. 20A. FIG. 20C is an explanatory drawing illustrating an example of a configuration for fixing the joining portion shown in FIG. 20B. FIG. 20D is an explanatory drawing illustrating another example of a configuration for fixing the joining portion shown in FIG. 20B.

### BEST MODE FOR CARRYING OUT THE INVENTION

The embodiments of the preset invention will be described below with reference to the appended drawings. Like elements are assigned with like reference numerals and explanation thereof may be omitted. The drawings schematically illustrate the constituent elements for the sake of convenience of explanation and do not always accurately represent the shape thereof.

### Embodiment 1

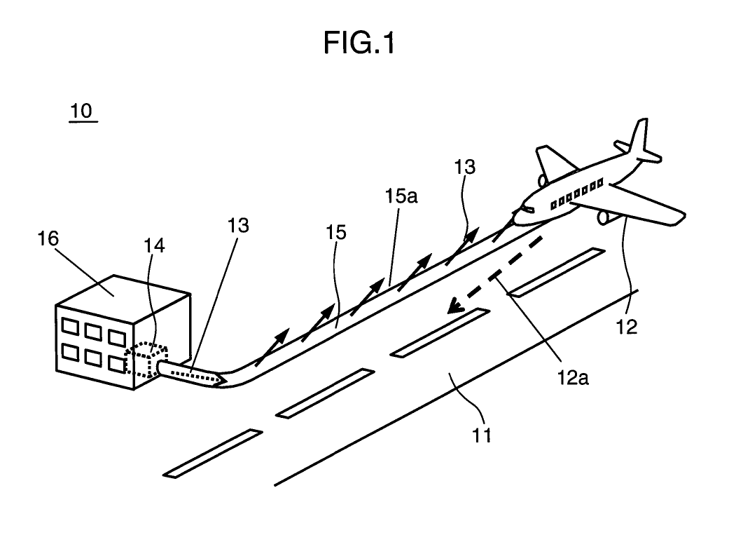

An embodiment of the present invention will be described below with reference to FIG. 1 to FIG. 11.

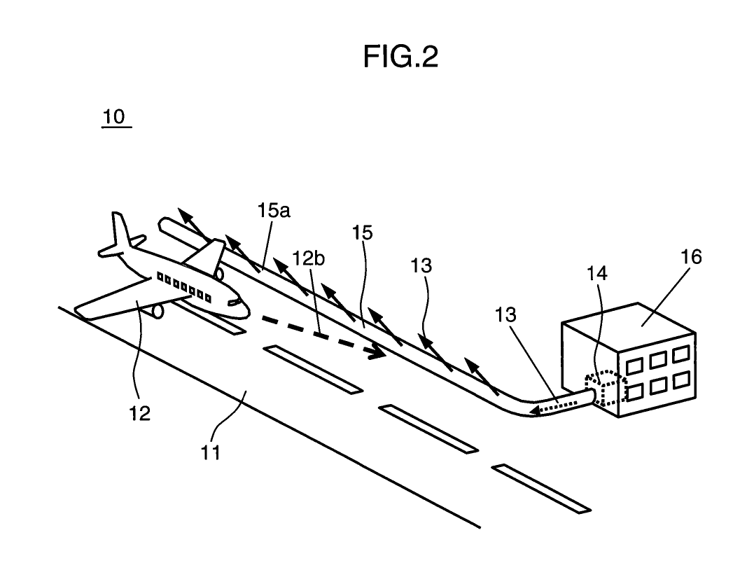

FIG. 1 and FIG. 2 illustrate a case in which a guiding device 1 is used as a guidance light of a runway of an airport in one configuration example of the guiding device of the present embodiment.

FIG. 1 shows a state in which an airplane 12 (mobile body) lands in the direction of an arrow 12a on a runway (road surface) 11 of an airport. FIG. 2 shows a state in which the airplane 12 (mobile body) takes off in the direction of an arrow 12b.

As shown in FIG. 1 and FIG. 2, the guiding device 10 of the present embodiment is provided with a laser light source 14 that emits a laser beam 13 and a linear guiding portion 15 composed of a fiber 15a that guides the laser beam 13 and is disposed on and along the runway 11 where the airplane 12 moves. The linear guiding portion 15 has a function of guiding the airplane 12 by irradiating the laser beam 13 with good directivity in the direction along the runway 11.

The laser light source 14 of the present embodiment is adequately disposed inside an administrative building 16 located outside the runway (road surface) 11.

The operation temperature of laser light sources and drive circuits is generally preferred to be maintained at a normal temperature level to extend the service life thereof. Accordingly, in the present embodiment, the laser light source 14 is disposed indoors in order to prevent the laser light source from operating under a high temperature environment even in a blazing summer heat. Further, in this case, the laser light source 14 can be adequately protected from water, atmosphere, and sunlight. As a result, the service life of the laser light source 14 can be extended and therefore the service life of the entire guiding device 10 can be extended.

The present embodiment is not limited to the above-described configuration and it is also possible, for example, to provide an adequate storage chamber below the runway 11 and dispose the laser light source 14 inside the storage chamber. As a result, the laser light source 14 can be adequately protected from water, atmosphere, and sunlight in the same manner as when it is disposed in the room of the administrative building 16.

Even when it is necessary to replace the laser light source 14 because of the end of the service life thereof, the fiber 15a that is a light guiding portion is not necessary to replace, and only the laser light source 14 located inside the administrative building 16 can be replaced. Therefore, the laser light source 14 can be replaced, regardless of the presence of the airplane 12 on the runway 11 and therefore the convenience can be increased. In addition, since the replacement is done in one location, the number of operations required for the replacement can be reduced. It goes without saying that the installation location of the laser light source 14 is not limited to that inside the administrative building or storage chamber, provided that the laser light source is not exposed to high temperature and can be easily replaced.

Because of the object of use thereof, the linear guiding portion 15 is disposed outdoors and connected to the laser light source 14 located inside the administrative building 16. In the linear guiding portion 15, the laser beam 13 emitted from the laser light source 14 propagates inside the fiber 15a. The fiber 15a constituting the linear guiding portion 15 is composed of electrically insulating quarts glass or resin and is highly flexible. Therefore, the linear guide portion 15 can be disposed in the desired location both longitudinally and transversely along the runway 11 of the airport, for example, as shown in FIG. 1 and FIG. 2.

In the guiding device 10 of the present embodiment, the laser light source 14 is disposed, as described hereinabove, in an adequate position inside a room of the administrative building 16 in order to avoid the exposure to water, atmosphere, and sunlight. Therefore, the guiding device 10 can be operated with good stability for a long time.

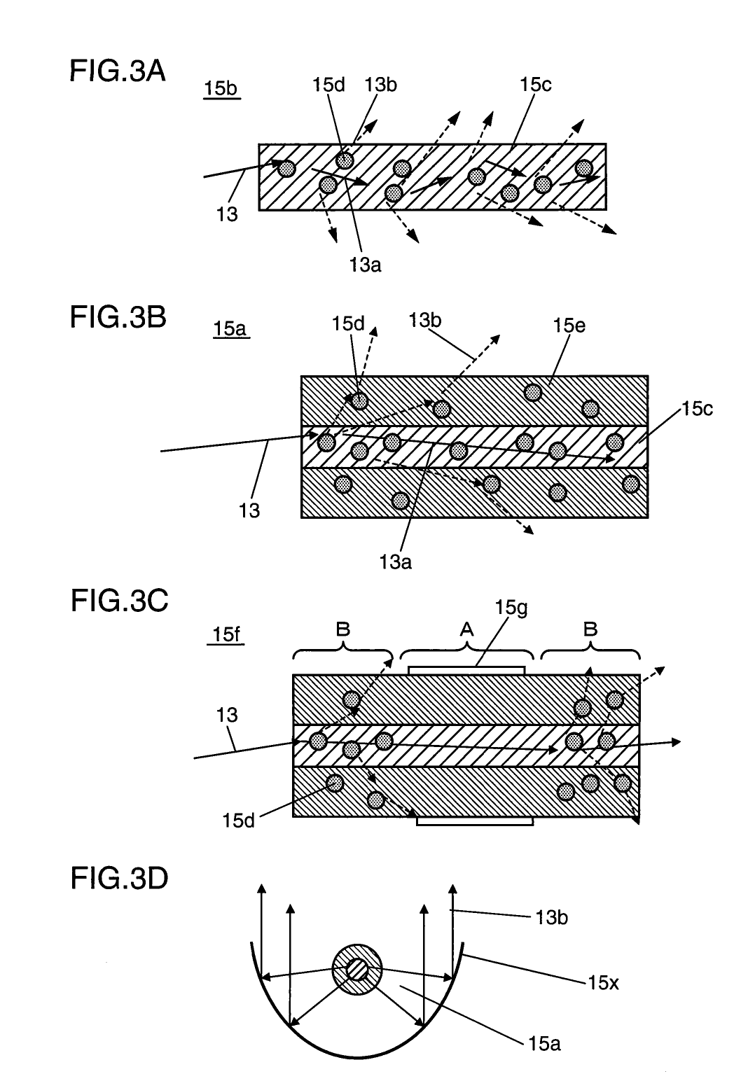

FIG. 3A and FIG. 3B are cross-sectional views illustrating configuration examples of the fiber used in the guiding device 10.

A fiber 15b shown in FIG. 3A is composed only of a core 15c and formed from an electrically insulating transparent material such as quartz glass or resin. The core 15c includes, for example, a diffusing material 15d such as beads that have a refractive index different from that of the core 15c. The laser beam 13 propagates as a laser beam 13a inside the fiber 15b. The propagation path of part of the laser beam 13a is curved by the diffusing material 15d, and this part is irradiated with good directivity as a laser beam 13b in the forward direction along the linear guiding portion 15.

A fiber 15a shown in FIG. 3B is constituted by a core 15c and a cladding 15e. In the example shown in this figure, both the core 15c and the cladding 15e constituting the fiber 15a include a diffusing material 15d. However, the fiber 15a of the present embodiment is not limited to the above-described configuration. For example, when the refractive index of the core 15c is set higher than that of the cladding 15e, as in the usually used fibers, the core 15c may include the diffusion material 15d. However, when the refractive index of the cladding 15e is set higher than that of the core 15c, the diffusion material 15d may be included in either the cladding 15e or the core 15c. In the fiber 15a shown in FIG. 3B, similarly to the fiber 15b shown in FIG. 3A, the laser beam 13 propagates as the laser beam 13a inside the fiber 15a. The propagation path of part of the laser beam is curved by the diffusing material 15d and this beam goes out of the fiber 15a via the curved path. As a result, it is irradiated as a laser beam 13b with good directivity in the forward direction along the linear guiding portion 15.

Thus, a linear guiding portion can be easily realized by using a fiber including the diffusing material 15d in either the cladding 15e or the core 15c. Further, with such a configuration, the desired laser beam 13 can be easily irradiated with good directivity by appropriately designing the arrangement or density of the diffusing material 15d inside the fiber 15.

The linear guiding portion 15 of the present embodiment illustrated by FIG. 1 and FIG. 2 is composed of the fiber 15a disposed on and along the runway 11. The fiber 15a may be constituted by a propagation portion A in which the laser beam 13 from the laser light source 14 propagates with low loss and an irradiation portion B through which the laser beam 13 is irradiated with good directivity by scattering.

The fiber of the present embodiment is preferably configured to have a coating on the propagation portion A and include no diffusion material 15d inside the propagation portion A, as in the fiber 15f shown in FIG. 3C. As a result, the laser beam 13 can propagate with low loss in the propagation portion A. By contrast, the irradiation portion B includes the diffusing material 15d thereby enabling the irradiation of the laser beam 13 with good orientation.

The entire portion of the fiber disposed along the runway 11 may be the irradiation portion B, or only part thereof may be the irradiation portion B, as shown in FIG. 3C. In this case, the diffusing material 15d may be included only in the irradiation portion B, and a coating 15g may be removed only from the irradiation portion B. In this case, a portion outside the irradiation portion B is the propagation portion A that is provided with a coating and ensures low-loss propagation of the laser beam 13 from one irradiation portion B to the next irradiation portion B with low loss.

In the case of a fiber in which the above-described irradiation portions B and propagation portions A are formed repeatedly with a short period, uniformly bright irradiation can be ensured over the entire region of the fiber by increasing the ratio of the irradiation portions B in the downstream direction. Thus, the quantity of light in the laser beam propagating inside the fiber decreases in the downstream direction. In this case, by increasing the ratio of the irradiation portions B inside the fiber, as described hereinabove, it is possible to compensate the brightness of the emitted laser beams, thereby enabling uniformly bright irradiation. Where the entire region inside the fiber is the irradiation portion B, it is desirable that the amount of the diffusing material 15d per unit length be increased in the downstream direction of the fiber. With such a configuration, by increasing the amount of the diffusing material 15d per unit length in the downstream direction in which the quantity of light in the laser beam decreases, it is possible to increase the quantity of light in the laser beam that is taken out, thereby enabling uniformly bright irradiation over the entire region of the fiber, in the same manner as in the above-described configuration.

Further, in the configuration shown in FIG. 3A to FIG. 3C, it is preferred that the circumference of the fibers 15a, 15b, and 15f be covered with a mirror. As a result, the laser beam 13 can go out with even better directivity. As a result, visibility and irradiation effect can be further improved. FIG. 3D is a cross-sectional view illustrating a configuration example including the fiber 15a and a mirror 15x. When the mirror 15x is disposed around the fiber 15a, it is preferred that, for example, a paraboloidal mirror be used as the mirror 15x. As a result, the laser beams 13b that have gone out of the fiber 15a and have been reflected by the mirror 15x can be emitted in substantially the same direction. It is preferred that the diameter of the region including the diffusing material 15d (the cladding diameter in the case of the fiber 15a shown in FIG. 3). This is because the smaller is the diameter of the region including the diffusing material 15d, the higher is the directivity of the laser beam reflected by the paraboloidal mirror 15x. Accordingly, since the core diameter and clad diameter of the fiber are generally small, it is preferred that a fiber be used as the liner guiding portion, as in the present embodiment.

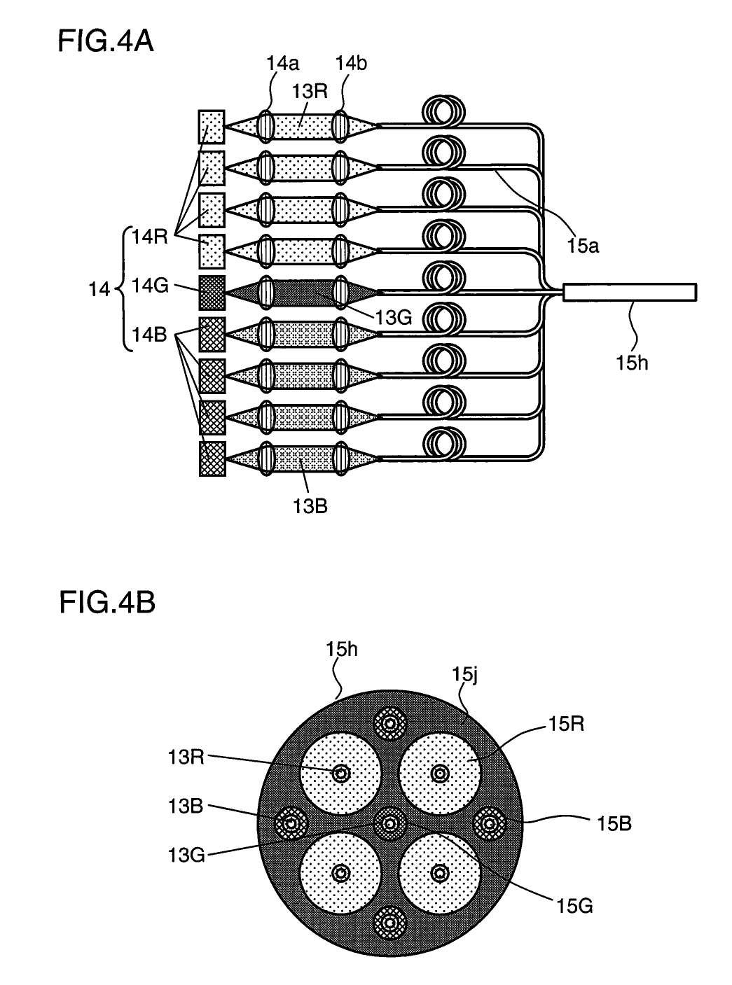

FIG. 4A is a schematic diagram illustrating a configuration example of a laser light source 14 and an optical system such as a fiber 15h guiding the laser beam 13 from the laser light source 14 that are used in the guiding device 10 of the present embodiment. FIG. 4B is a cross-sectional view illustrating a configuration example of the fiber 15h of the optical system shown in FIG. 4A.

As shown in FIG. 4A, the laser light source 14 has a configuration including at least an RGB beam source composed of a red laser light source (R beam source) 14R emitting a red laser beam (R beam) 13R, a green laser light source (G beam source) 14G emitting a green laser beam (G beam) 13G, and a blue laser light source (B beam source) 14B emitting a blue laser beam (B beam) 13B. More specifically, for example, the R beam source 14R and the B beam source 14B use high-output semiconductor lasers emitting the R beam 13R and the B beam 13B with a wavelength, for example, 640 nm and 445 nm, respectively, and the G beam source 14G uses a high-output SHG laser excited by a semiconductor laser and outputting the G beam 13G with a wavelength of 535 nm.

With the above-described configuration, laser beams 13 with rich color and excellent color reproducibility can be emitted and therefore visibility of the guiding device 10 can be further improved.

Further, when a laser light source including no RGB beam source is used as the laser light source 14 constituting the linear guiding portion 15, it is preferred that a beam source including at least the G beam source 14G be used. In this case, it is preferred that a high-output SHG laser excited by a semiconductor laser and emitting the G beam 13G with a wavelength close to 535 nm be used. With such a configuration, the green laser beam 13 with high visibility to human eyes can be used and therefore visibility can be increased with good efficiency at a low power consumption level.

The laser beams 13 emitted from the laser light source 14 shown in FIG. 4A are converted into parallel beams by collimator lenses 14a. The laser beams 13 converted into the parallel beams by the collimator lenses 14a are then converged by objective lenses 14b into optical fibers 15a. A plurality of fibers 15a are combined to obtain a fiber 15h (a bundle fiber in the present embodiment) and used as the linear guiding portion 15.

FIG. 4B shows a configuration example of the fiber 15h. Thus, a fiber 15G serving as a waveguide for the G beam 13G is provided in the center and surrounded by the fibers 15R and fibers 15B serving as waveguides for the R beams 13R and B beans 13B, respectively. These fibers 15R, 15G, and 15B are integrated by a cladding 15j.

In this case, when a single-mode laser is used as the laser light source 14, it is possible to use fluctuations of the laser beam 13 outgoing from the linear guiding portion 15 to the outside, those fluctuations being caused by spectral noise. Thus, spectral noise causes the laser beam 13 to fluctuate in time and space and therefore, the vicinity of the laser beam 13 from the linear guiding portion 15 can be further increased.

Further, the above-described configuration makes it possible to realize a guiding device 10 that is simple in structure and installation and easy to maintain and excels in visibility.

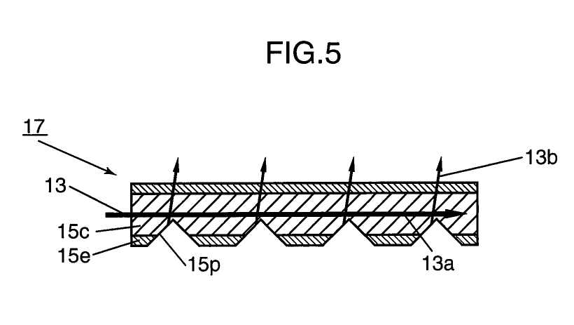

FIG. 5 is a cross-sectional view illustrating another configuration example of the fiber for use in the guiding device 10 of the present embodiment.

As shown in FIG. 5, a fiber 17 is constituted by a core 15c through which the laser beam 13a propagates and a cladding 15e. The fiber 17 is further provided with a plurality of mirrors (or prisms) 15p for emitting the laser beam 13 that has entered the core 15c along the runway 11 (see FIG. 1) from the cladding 15e to the outside.

With such a configuration, the laser beam 13b can be easily emitted with even better directivity. The configuration shown in FIG. 3C can be also applied to the fiber 17. Thus, a linear guiding portion may be configured by disposing alternately the irradiation portions B that include the fiber 17 shown in FIG. 5 and irradiate the laser beam 13 with good directivity by scattering and the propagation portions A through which the laser beam 13 from the laser light source 14 propagates with low loss.

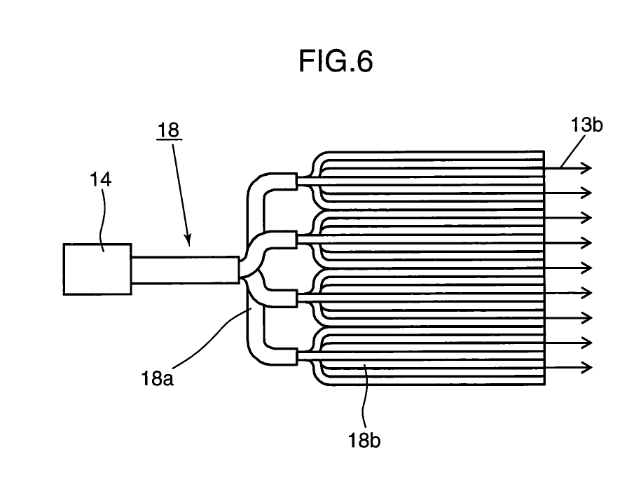

FIG. 6 is a plan view illustrating yet another configuration example of the fiber for use in the guiding device 10 in the present embodiment. As shown in FIG. 6, a fiber 18 directly connected to the laser light source 14 is branched into a plurality of branch fibers 18a (four in the present embodiment). Each branch fiber 18a is further constituted by a plurality of unit fibers 18b arranged in a flat pattern. With such a configuration, the laser beam 13b can be irradiated in a plane-like form, rather than linear form along the runway 11, and additional increase in visibility can be realized. The fiber 18 is not limited to the above-described configuration. For example, this fiber may be configured by directly connecting a plurality of unit fibers 18b arranged in a flat pattern, without using the branch fibers 18a. In this case, a configuration in which the laser beam 13b is irradiated in a plane-like form along the runway 11 may be also used.

The configuration shown in FIG. 3C can be also applied to the fiber 18 shown in FIG. 6. Thus, a configuration may be used that includes the irradiation portions B that irradiate the laser beam 13 with good directivity by scattering and the propagation portions A through which the laser beam 13 from the laser light source 14 propagates with low loss.

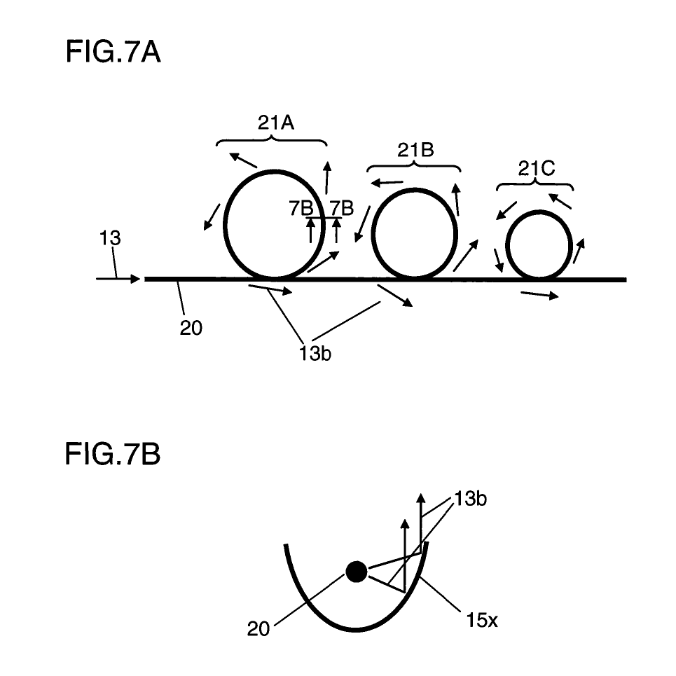

FIG. 7A shows yet another configuration example of the fiber for use in the guiding device 10 of the present embodiment. As shown in FIG. 7A, the fiber 20 forms a plurality of loops 21A, 21B and 21C. The laser bean 13 entering the fiber 20, first, propagates in the loop 21 A. Where the total reflection condition is exceeded at the boundary of the core and the cladding and on the boundary of the cladding and the atmosphere in the loop 21A, the laser beam 13b exits the fiber 20 radially and propagates to the loop 21B. Similarly to the case of the loop 21A, where the total reflection condition is exceeded at the boundary of the core and the cladding and on the boundary of the cladding and the atmosphere, the laser beam 13b exits the fiber 20 radially and propagates to the loop 21C. Where the total reflection condition is exceeded when the beam passes through the loop 21C, the beam goes out of the fiber 20. In this case, the quantity of light in the beam propagating inside the fiber 20 decreases with the transition to the downstream side of the fiber 20. Accordingly, it is preferred that the loop diameter decrease with the transition to the downstream side of the fiber 20, as shown in FIG. 7A. As a result, the total reflection condition is easily exceeded inside the fiber, and the uniformity of quantity of light of the outgoing beam can be improved.

FIG. 7B is a cross-sectional view taken along the 7B-7B line in FIG. 7A. It is preferred that a mirror be disposed around the fiber 20, as shown in FIG. 7B, in the configuration of the fiber 20 shown in FIG. 7A. With such a configuration, for example, when a paraboloidal mirror 15x is disposed along the fiber 20, as shown in FIG. 7B, the laser beams 13b exiting the fiber circumferentially are reflected by the paraboloidal surface 15x and propagate radially upward within a predetermined angle. Therefore, even though the fiber 20 contains no diffusing material, a laser beam can be taken out of the fiber with good directivity. This allows a further cost reduction of the guiding device.

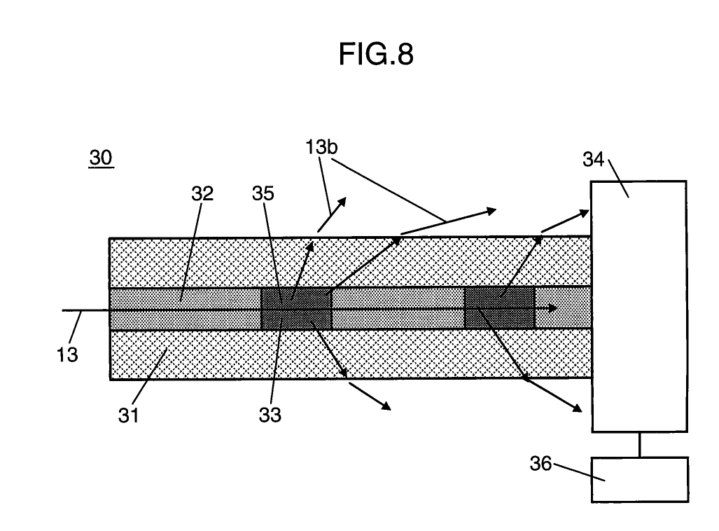

FIG. 8 shows a schematic configuration of another fiber for use in the guiding device 10 of the present embodiment. As shown in FIG. 8, a fiber 30 includes a cladding 31 with a hollow inside and liquids 32 and 33 injected into the cladding 31. The liquid 33 is a transparent liquid including a diffusing material 35 (for example, fine transparent particles with a diameter of about several micron that are produced from polystyrene or polymethyl methacrylate). A liquid that is not miscible with the liquid 33 is used as the liquid 32. For example, when water is used as the liquid 33, a nonpolar solvent such as dichloromethane and hexane can be used. These liquids 32 and 33 correspond to a core.

An end surface of the fiber 30 of the above-described configuration on the side opposite that of the light incidence side is connected to a pump 34. The pump 34 accommodates inside thereof the liquid 32 and the liquid 33 including the diffusing material 35 and is configured such that the liquid 32 and the liquid 33 including the diffusing material 35 can be alternately jetted out into the cladding 31 under the control performed by a control unit 36. As a result, the liquid 33 including the diffusing material 35 can be disposed in any position inside the fiber 30, as shown in FIG. 8. In this state, when the laser beam 13 enters the fiber 30 from a side (left side in the figure) opposite that where the pump 34 is provided, the laser beam 13 propagates with good efficiency in the liquid 32 containing no diffusing material 35.

When the refractive index of the liquid 32 and liquid 33 is higher than the refractive index of the cladding 31, the laser beam 13 that has entered the liquid 32 or the liquid 33 propagates, while undergoing total reflection at a boundary surface of the cladding 31 and the liquid 32 and at a boundary surface of the cladding 31 and the liquid 33, in the same manner as is usually observed in quartz fibers. In this case, where the incoming laser beam 13 reaches the liquid 33, the laser beam is diffused by the diffusing material 35 located inside the liquid 33 and exits the fiber 30. The quantity of light exiting from each position of the fiber 30 can be set to a random value by adjusting the density of the diffusing material 35 in the same manner as in the case of the fiber 15f shown in FIG. 3C or by adjusting the ratio at which the liquid 32 and the liquid 33 are discharged from the pump 34.

Further, by actuating the pump 34 after the laser beam 13 has entered the fiber 30, it is possible to perform the adjustment by moving the liquid 32 and the liquid 33 inside the fiber 30. As a result, the irradiation position can be adjusted to a desirable position.

In another possible configuration, three fibers of the above-described configuration are bundled together, red, blue, and green laser beams are introduced into the fibers by one color per fiber, and the colors of the fibers are combined together. As a result, any position can be irradiated with any color.

When the refractive index of the liquid 32 or the liquid 33 serving as a core is less than the refractive index of the cladding 31, the laser beam 13 that has entered the fiber 30 propagates inside the fiber 30, while undergoing total reflection at a boundary of the cladding 31 and the atmosphere, rather than on the boundary of the cladding 31 and the liquid 32 or the liquid 33. In this case, even when the position of the liquid 33 is reached inside the fiber 30, the light present inside the cladding 31 at this time passes through without diffusion.

Accordingly, it is preferred that the cross-sectional area of the cladding 31 is larger than that of the core in the location into which the liquid 32 and the liquid 33 have been injected. In this case, since the laser beam can be caused to propagate a long distance in the fiber 30, such a configuration is effective when gradual diffusion over a long distance is desired. In the present embodiment, a configuration using two kinds of liquids, namely, the liquid 32 and the liquid 33, is described, but such a configuration is no limiting. Thus, it goes without saying that three or more kinds of liquids may be used or the diffusing material 35 may be introduced in the liquid of one kind. When the diffusing material 35 is introduced in the liquid of one kind, the effect similar to that obtained with the fiber 15a shown in FIG. 3B is demonstrated. Further, in the configuration shown in FIG. 8, the diffusing material 35 is not included in the liquid 32, but the liquid 32 may include the diffusing material 35. In this case, light emission of different brightness can be obtained by changing the density of the diffusing material or particle diameter thereof in the adjacent liquid 32 and liquid 33. Light emission of other patterns can be also obtained by using three or more kinds of liquids.

FIG. 8 illustrates a configuration in which the liquid 33 includes the diffusing material 35. However, the present embodiment is not limited to this configuration. Thus, a fluorescent material (for example, nanosilicon, ZnS:Ag (blue), Zn₂SiO₄:Mn (green), and Y₂O₃:Eu (red)) can be included instead of the diffusing material. In this case, for example, when the incoming laser beam is of a blue color, it is possible to change the color to red or green by changing the type of the fluorescent material or, in the case of nanosilicon, by changing the particle size thereof. Thus, light emission of any color can be obtained in any position, while using a single fiber. Further, even when a fluorescent material is used instead of the diffusing material, the effect demonstrated by the difference between the refractive indexes of the liquid 32 and the liquid 33 and the refractive index of the cladding and the effect produced by using three or more kinds of liquid can be obtained in the same manner as in the case when the diffusing material is used.

The kinds of the liquid 32 and the liquid 33 are not limited to the above-described examples, provided that the liquids are transparent and mutually insoluble.

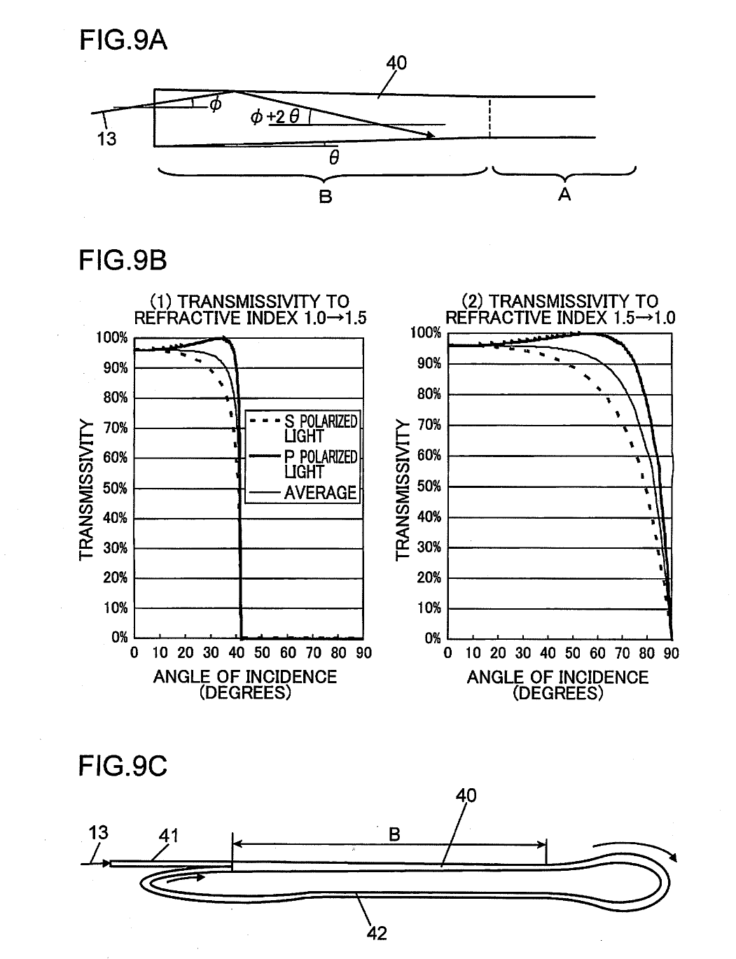

FIG. 9A to FIG. 9C are schematic configuration diagrams of another fiber used in the guiding device 10 of the present embodiment. The fiber shown in FIG. 9A is a tapered fiber tapered fiber 40 that varies in the cross section diameter with the distance from the laser light source. The laser beam 13 enters the fiber 40 from the thick side thereof.

Generally a laser beam enters the tapered fiber 40 from a thin side and exits from a thick side, so that the outgoing laser beam is close to a substantially parallel beam. However, in the configuration shown in FIG. 9A and FIG. 9B, as described above, the laser beam 13 enters the fiber from the thick side. As a result, the laser beam 13 propagating inside the tapered fiber 40 can be steadily taken out to the outside of the fiber 40.

As shown in FIG. 9A, in the laser beam 13 that has entered at an angle φ the tapered fiber 40 having a taper angle θ, the angle increases by 20 each time the laser beam is reflected at the end surface of the tapered fiber 40. Further, where the total reflection condition at the boundary surface of the tapered fiber 40 and the atmosphere is exceeded as the laser beam undergoes repeated reflections at the end surface of the tapered fiber 40, the laser beam 13 exits to the outside of the tapered fiber 40.

The tapered fiber 40 shown in FIG. 9A may be also covered with a cladding including the diffusing material 15d, as shown in FIG. 3B, to obtain a configuration in which the laser beam 13 exits the fiber coated with the cladding 15e including the diffusion material 15d as in the configuration shown in FIG. 3B. In this case, the laser beam 13 can be additionally subjected to diffusion before exiting the fiber and therefore the laser beam 13 can be readily taken out of the tapered fiber 40.

In the tapered fiber 40, the refractive index of the cladding is usually made lower than that of the core, whereby total reflection is induced at the end surfaces of the core and the cladding and the light is caused to propagate a long distance. However, when the light is taken out of the tapered fiber 40 as in the present embodiment, the light can be easily taken out of the tapered fiber 40 over a long region with a uniform distribution by increasing the refractive index of the cladding over that of the core.

For example, when light enters a substance with a high refractive index (for example, acrylic resin or the like: refractive index 1.5) from a substance with a low refractive index (for example, air: refractive index 1.0), the transmissivity of light (average for S and P polarized light) changes from 0 to 90% for example within a very narrow range (5°) of the angle of incidence of 42° to 37° (see (1) in FIG. 9B). This result also indicates that the transmissivity of the laser beam 13 into the cladding rises abruptly as the beam is repeatedly reflected inside the tapered fiber 40. Therefore, uniform irradiation is difficult to obtain over a long region.

However, when the incidence direction is reversed and the laser beam enters a substance with a low refractive index (for example, air: refractive index 1.0) from a substance with a high refractive index (for example, acrylic resin or the like: refractive index 1.5), the range of the angle of incidence in which the transmissivity of light (average for S and P polarized light) changes from 0 to 90% is greatly widened to about 30° (see (2) in FIG. 9B), that is, from 90° to 60°. This result also indicates that the transmissivity does not rises abruptly although the laser beam undergoes repeated reflections inside the fiber 40. Therefore the attenuation of the laser beam inside the core caused by transmission to the cladding of the light propagating inside the fiber 40 and the increase in transmissivity caused by the decrease in the angle of incidence caused by repeated reflections cancel each other and uniform irradiation over a long region can be attained.

For example, when a beam having a Gaussian distribution with a beam radius of 400 μm (1/ê2) and a spread angle of 0.5° (half-width: 1/ê2) enters a tapered fiber with taper angle θ of 0.02°, a core radius at a thick side of 500 μm, a length of 1 m, a refractive index of 1.44 of the core, and a refractive index of 1.49 of the cladding including a diffusing material, the light can propagate with a spread in luminance within a range of 20% over the region covering almost the entire length of the fiber.

When a beam having a Gaussian distribution with a beam radius of 400 μm (1/ê2) and a spread angle of 0.9° (half-width: 1/ê2) enters the same fiber having a refractive index of 1.0 (that is, hollow) of the core, the light can propagate with a spread in luminance within a range of 20% over the region covering almost the entire length of the fiber. It goes without saying that a variety of combinations can be set correspondingly to the desired irradiation length or properties (refractive index, core diameter, and the like) of the fiber used.

In the above-described example, a case is explained in which the refractive index of the core in the tapered fiber is lower than the refractive index of the cladding. However, even in the usual fiber that has not been tapered, where the refractive index of the cladding is made higher than that of the core, although the angle of incidence on the fiber end surface is not changed, the effect of gradually taking the light to the outside of the fiber is clearly demonstrated, as in the tapered fiber. Therefore, the laser beam can be irradiated over a long region even in the case of the usual fiber that has not been tapered.

Further, it is preferred that the taper angle θ vary depending on the location in the tapered fiber 40. In this case, the quantity of outgoing light in any location can be adjusted. Thus, by increasing the taper angle θ in a location with a low luminance, it is possible to increase the intensity of the laser beam exiting the fiber from this position and a more uniform laser beam can be obtained.

Similarly to the configuration shown in FIG. 3C, the above-described configuration also may be constituted by propagation portions A in which the laser beam 13 from the laser light source 14 propagates with low loss and irradiation portions B that irradiate the laser beam 13 with good directivity by diffusion. In this case, as shown in FIG. 9A, the tapered fiber 40 may be taken as the irradiation portion B and a fiber that has not been tapered may be connected as the propagation portion A to the irradiation portion B. Thus, in the fiber that has not been tapered, the angle of the laser beam increases. Therefore, in the fiber that has not been tapered, the total reflection condition is prevented from being exceeded and therefore no laser beam is irradiated. Therefore, where the portions of the taper fiber 40 are used as the irradiation portions B and the portions that have not been tapered are used as the propagation portions A, the irradiation portions and propagation portions can be provided as in the configuration shown in FIG. 3C.

FIG. 9C is a configuration diagram of a fiber in which even more uniform and loss-free irradiation is enabled by using the tapered fiber 40 explained with reference to FIG. 9A. In this configuration, a fiber 41 with a diameter less than the diameter of the thick side of the tapered fiber 40 is connected to the thick side of the tapered fiber 40. A fiber 42 with a diameter equal to that of the thick side of the tapered fiber 40 is connected to the thin side of the tapered fiber 40. The end portions of the fiber 42 at the side opposite that connected to the thin side of the tapered fiber 40 is connected to the thick side of the tapered fiber 40.

The laser beam 13 that has entered the fiber 41 and exited from the fiber 41 enters the tapered fiber 40. The laser beam 13 that has entered the tapered fiber 40 is little by little taken to the outside of the tapered fiber 40, as shown in FIG. 9A, while propagating inside the tapered fiber 40. The laser beam 13 remaining inside the tapered fiber 40 enters the fiber 42. Thus, by smoothly returning the fiber 42 to the thick side of the tapered fiber 42, it is possible to return, without loss, the laser beam 13 propagating inside the fiber 42 to the thick side of the tapered fiber 40. The laser beam 13 then repeatedly circulates inside the loop formed by the tapered fiber 40 and the fiber 42 till the laser beam is taken out from the tapered fiber 40. As a result, the incoming laser beam 13 can be used for loss-free irradiation. Further, even when no diffusing material is contained in the tapered fiber 40, light scattering is induced by impurities present, although in a very small amount, inside the tapered fiber 40, and the laser beam can be taken out of the tapered fiber 40 by very small amounts.

Furthermore, even when no taper is formed in the tapered fiber 40, the laser beam can circulate, while being scattered at a very low rate, in the loop constituted by the tapered fiber 40 and the fiber 42. As a result, uniform irradiation from the tapered fiber 40 and the fiber 42 can be obtained.

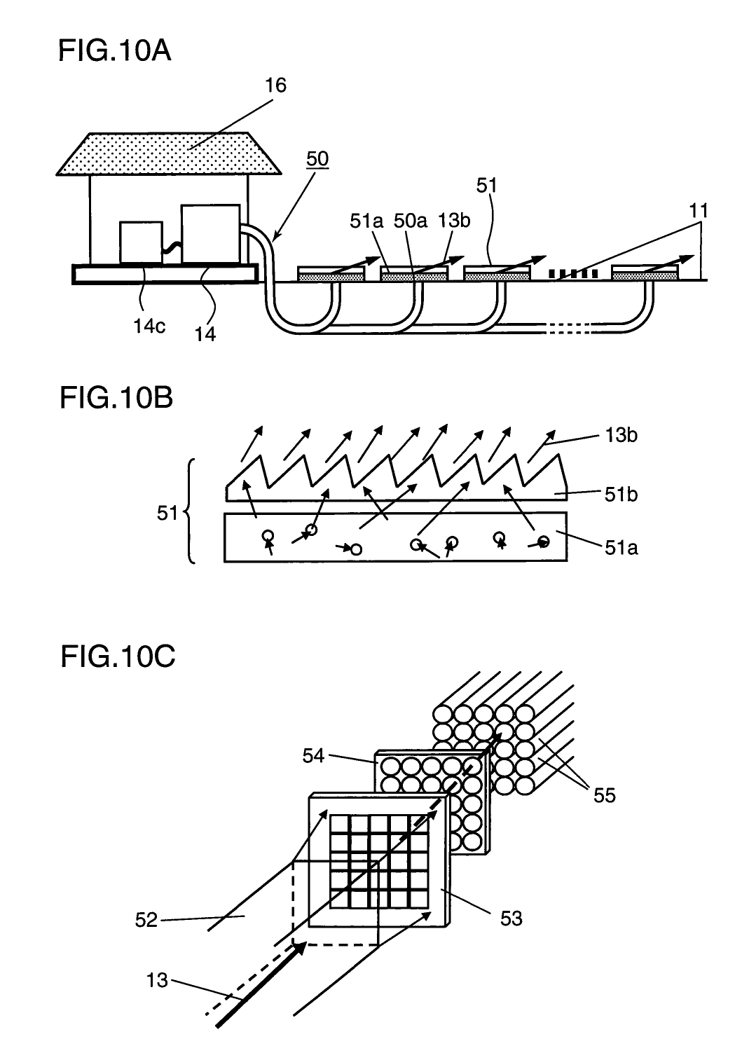

FIG. 10A to FIG. 10C are side views illustrating schematically yet another configuration example of the fiber for use in the guiding device 10 of the present embodiment. In this configuration example, as shown in FIG. 10A, a power source 14 is accommodated in an administrative building 16 and connected to a power source 14c of the administrative building 16. A fiber 50 is connected to the power source 14.

As shown in FIG. 10A, the fiber 50 is branched outside the administrative building 16, and a distal end portion 50a of each branch fiber is further connected to a light-guiding plate 51 for plane-like irradiation of laser beam 13b. The laser beam 13b scattered by a scattering portion 51a of the light-guiding plate 51 can be taken out with good directivity to the outside, for example, from a prism sheet 51b such as shown in FIG. 10B.

In this case, since plane-like irradiation of the laser beam 13b can be obtained, the laser beam can be irradiated such that has a certain width on the runway 11. As a result, further improvement in visibility can be realized.

With the configuration such as shown in FIG. 10C, the color and intensity of the light-guiding plates 51 connected to each fiber can be randomly set. Thus, a bundle fiber is used as the fiber 50 and each of the fibers 55 constituting the bundle fiber is connected to the respective light-guiding plate. In the laser beam 13, the laser beams of three colors, namely, red, blue, and green, are mixed, and a spatial modulation element 53 is irradiated with light having substantially uniform intensity distributions for red, blue, and green colors in a cross-sectional plane in a rod integrator 52, as shown in FIG. 10C. Where the laser beams that have been transmitted by each pixel of the spatial modulation element 53 pass through a microlens array 54, the beams are converged and coupled with respect to an entry port of each fiber 55 constituting the bundle fiber. In such a configuration, the quantity of light and color of the laser beam entering each fiber 55 can be controlled by controlling the transmissivity of each color in each pixel of the spatial modulation element 53. Therefore, the color and intensity of laser beams exiting from each light-guiding plate 51 can be randomly set.

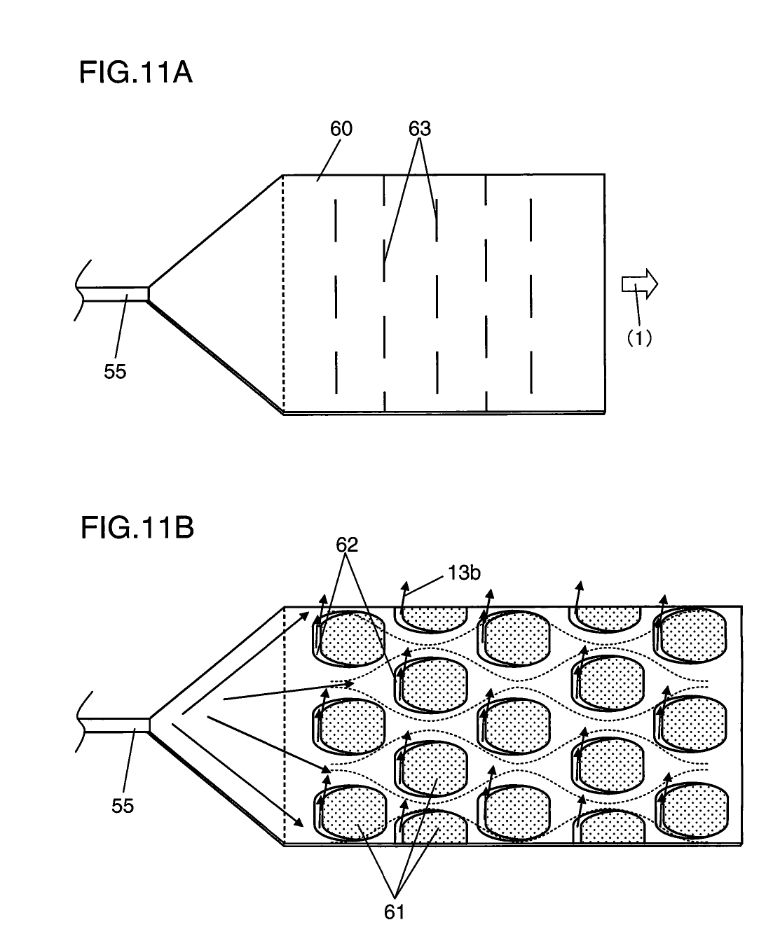

A light-guiding sheet 60 shown in FIG. 11A and FIG. 11B may be used instead of the light-guiding sheet 51 shown in FIG. 10. In this case, a wide range can be readily irradiated. As shown in FIG. 11A, the light-guiding sheet 60 is provided with alternating rows of slits. Where the light-guiding sheet 60 is pulled in the direction shown by arrow (1) in the figure in such a state, the light-guiding sheet 60 is mesh-like stretched as shown in FIG. 11 B and a plurality of apertures 61 can be provided.

Where the light-guiding sheet 60 is connected to the fiber 55 and the laser beam 13 enters the light-guiding sheet 60 from the fiber 55 in this state, the laser beam 13 propagates inside the light-guiding sheet 60. Part of the laser beam 13 can be irradiated with good directivity as a laser beam 13b from cross sections 62 facing upward in the vicinity of the apertures 61 produced by pulling the light-guiding sheet 60 in the direction of arrow (1).

Further, by changing the intensity of pulling in the direction of arrow (1), it is possible to change the orientation of the outgoing laser beam 13b. In the case of installation on a road surface, as in the present embodiment, for example, where the fibers 55 have a mesh-like arrangement and used as a linear guiding portion, when a mobile body passes above the fibers, the fibers can be cut. In such a case, in the fibers that have been cut, no laser beam can be irradiated as a linear guiding portion downstream of the cutting position.

Accordingly, where the above-described light-guiding sheet 60 is used, even if part of the propagation path is cut, the laser beam from other locations still propagates and therefore, the laser beam can be irradiated even downstream of the cutting position of the propagation path. As a result, a laser beam can be irradiated with good directivity within a wide range by using a simple configuration, and a highly reliable guiding device can be realized.

In the above-described configuration, it is preferred that the light-guiding sheet 60 be provided with a reflective film made from a metal or the like on the upper surface and lower surface before the light-guiding sheet 60 is stretched. As a result, the light can be more reliably confined within the light-guiding sheet 60 and therefore a fiber can be configured that ensures efficient and low-loss propagation.

With the above-described configuration, it is possible to realized a guiding device 10 that is simple in structure and installation and easy to maintain and excels in visibility.

The configuration shown in FIG. 3C can be also applied to the fiber 50 shown in FIG. 10A. Thus, a configuration can be obtained that includes the irradiation portions B that irradiate the laser beam 13 with good directivity by scattering and the propagation portions A in which the laser beam 13 from the laser light source 14 propagates with low loss.

The above-described configuration is not limiting provided that the prism sheet 51b shown in FIG. 10B has a light collection function. For example, a Fresnel lens sheet or a lens array sheet may be used.

### Embodiment 2

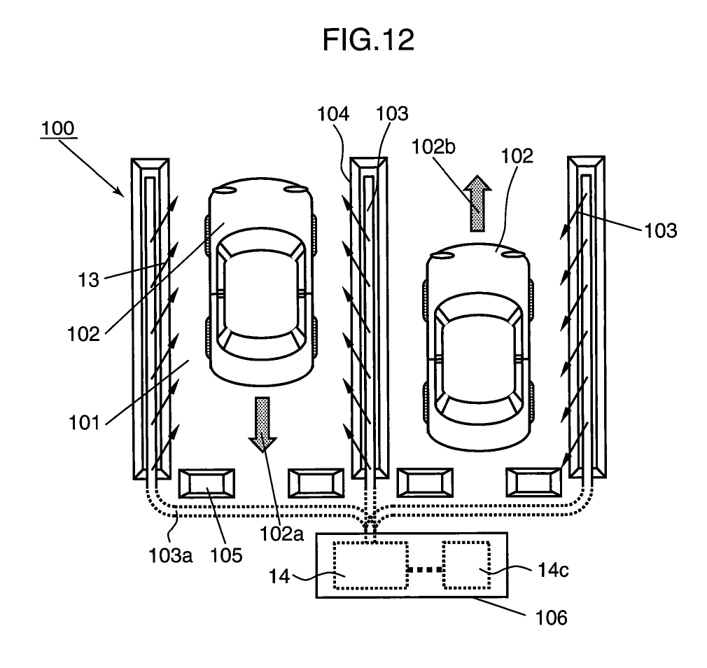

Another embodiment of the present invention will be described below with reference to FIG. 12 to FIG. 17.

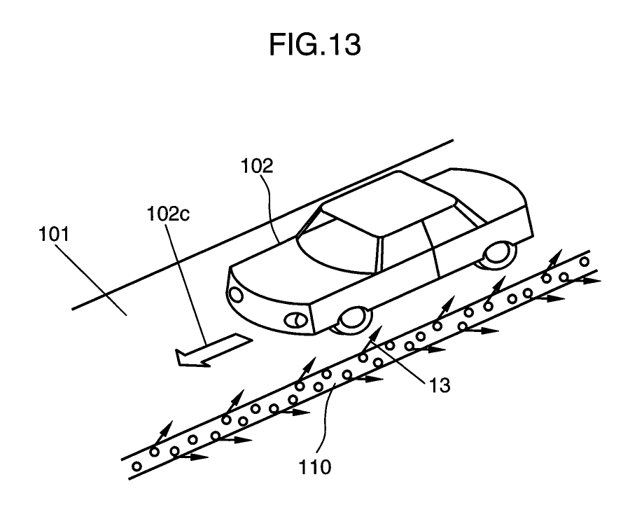

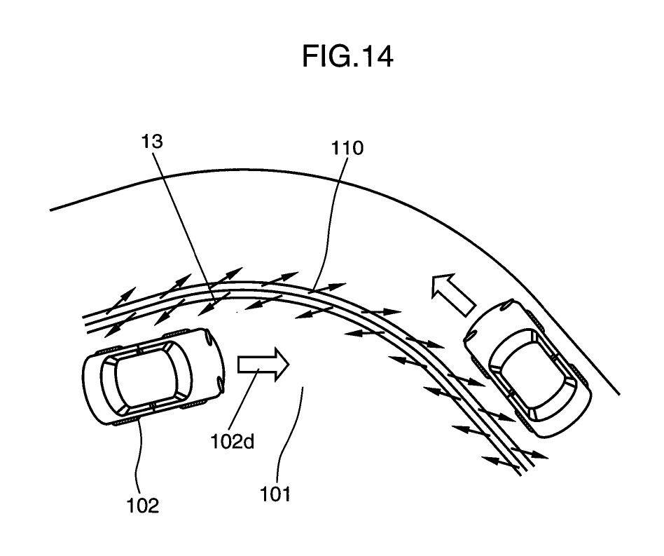

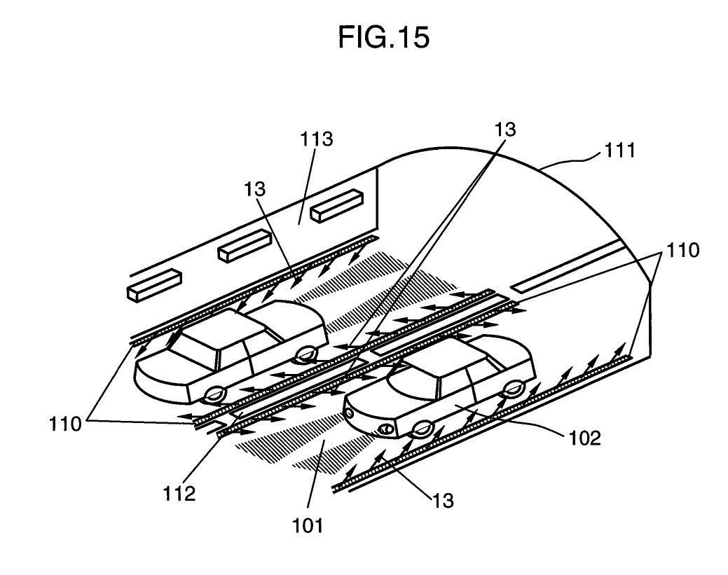

FIG. 12 is a top view illustrating a schematic configuration of a guiding device of the present embodiment. FIG. 13 is a perspective view representing an example in which the linear guiding portion of the guiding device of the present embodiment is disposed along the surface road of a highway or a general road. FIG. 14 is a perspective view representing an example in which the linear guiding portion of the guiding device of the present embodiment is disposed along the curved surface road of a highway or a general road. FIG. 15 is a perspective view representing an example in which the linear guiding portion of the guiding device of the present embodiment is disposed along the surface road inside a tunnel.

A guiding device 100 shown in FIG. 12 is used as a guidance light of a road surface 101 when an automobile 102 is parked or the parked automobile 102 is driven out of the parking area on a road surface 101 in a parking area in the night or in a parking garage.

As shown in FIG. 12, the guiding device 100 of the present embodiment is provided with a laser light source 14 emitting a laser beam 13 and a linear guiding portion 104 composed of a fiber 103 that guides the laser beam 13 and is disposed on and along a road surface 101 where an automobile (mobile body) 102 moves. The linear guiding portion 104 irradiates the laser beam 13 with good directivity in the direction along the road surface 101, thereby guiding the automobile (mobile body) 102 to and from the parking area.

When the automobile 102 is parked by backing up in the direction of an arrow 102a along the road surface 101 of the parking area till the wheel stoppers 105 are reached, the laser beam 13 is irradiated from the fibers 103 of the linear guiding portion 104. The laser beam 13 is thus irradiated with good directivity along the direction indicated by the arrow 102a. As a result, the driver of the automobile 102 can recognize with good visibility the position and direction of the linear guiding portion 104 in the parking area.

The laser light source 14 and a power source 14c for driving the laser light source are disposed in a control box 106. The control box 106 is provided outside the road surface 101 adjacently to the parking area or below the road surface 101 and disposed to be shielded from atmosphere or rain. Further, the fiber 103 constituting the linear guiding portion 104 and the fiber 103a that is connected to the laser light source 14 are buried below the road surface 101 as shown in FIG. 12.

When the automobile 102 is driven in the direction of an arrow 102b to exit from the parking area, the laser beam 13 is irradiated with good visibility for the driver along the direction indicated by the arrow 102a. As a result, the driver can recognize with good visibility the position and direction of the linear guiding portion 104 of the parking area and can safely drive the automobile out of the parking area.

With such a configuration, similarly to the above-described configuration, it is possible to realize the guiding device 100 that is simple in structure and installation and easy to maintain and excels in visibility. Further, with the present guiding device 100, since the laser beam 13 is irradiated with good visibility along the road surface 101, the laser beam can be easily seen by the driver of the automobile 102 and excellent visibility is attained. In addition, the laser light source 14 can be adequately protected from water, atmosphere, and sunlight and the service life of the device can be extended.

Further, for example, by attaching sensors to the wall surface, measuring the distance from the automobile 102 to the wall surface and automatically changing the color of the laser beam 13 correspondingly to the distance from the automobile 102 to the wall surface it is possible to warn the driver of the automobile 102 coming too close to the wall surface when the automobile is parked or driven out of the parking area, thereby ensuring safe driving.

FIG. 13 is an explanatory drawing illustrating another configuration example of the linear guiding portion of the present embodiment. As shown in FIG. 13, the linear guiding portion 110 is disposed along a road surface 101 of a highway or a general road and used as a line of a lane. The linear guiding portion 110 may use a configuration described in Embodiment 1, such as fibers 15a, 15b, and 15f shown in FIG. 3A to FIG. 3C.

For example, when the configuration of the fiber 15a shown in FIG. 3B is used, the linear guiding portion 110 is preferably configured to include a diffusing material in at least either of the core and the cladding constituting the fiber.

The linear guiding portion 110 can be easily realized by using such a fiber including a diffusing material in at least either of the core and cladding. Further, with such a configuration, by adequately designing the arrangement or density of the diffusing material inside the fiber, it is possible to irradiate the laser beam 13 easily with good directivity along the direction of an arrow 102c in which an automobile 102 is driven. As a result, the driver of the automobile 102 can recognize the linear guiding portion 107 as a lane line with good visibility even in the nighttime and safe driving can be ensured. On highways and general roads where passing is allowed, the center line is shown by a broken line (on highways, a white line with a length of 8 m and a spacing of 12 m; on a general road, a white line with a length and spacing of 5 m).

Therefore, the fiber of the above-described embodiment can be used in the below-described manner.

Thus, when the configuration of the fiber 15f shown in FIG. 3C is used, where the irradiation portions B including the diffusing material 15d are disposed in the portions corresponding to the white lines and the propagation portions A are disposed in the portions corresponding to spaces between the while lines, the configuration can be advantageously used, for example, for a center line of a road.

Likewise, when the configuration of the fiber 17 shown in FIG. 5 is used, where portions having an array of mirrors (or prisms) 15p are disposed in the portions corresponding to white lines and fibers having no mirror (or prisms) 15p are disposed in the portions corresponding to spaces between the while lines, the configuration can be advantageously used for a center line of a road. The same is true for fibers (20, 30, 40, and the like) of other configurations.

In the configuration shown in FIG. 13, similarly to the configuration of Embodiment 1 and the configuration shown in FIG. 12 of the present embodiment, the laser light source 14 and the power source 14c are disposed in an administrative building (not shown in the figure) or a control box (not shown in the figure) that are disposed in predetermined locations of service areas of highways, parking areas, toll zones, and general roads.

In the example shown in FIG. 13, the explanation refers to an automobile traveling on a road, but the present embodiment is not limited to such a configuration and it goes without saying that the aforementioned configuration can be similarly used for lines of automobile roads and sidewalks and also for lines of other intersecting roads.

FIG. 14 illustrates another configuration example of the linear guiding portion of the present embodiment. A linear guiding portion 110 shown in FIG. 14 is disposed along a curved road surface 101a of a highway or a general road. As shown in FIG. 14, even when the road surface 101 is curved, where the configuration such as that of the fibers 15a and 15b shown in FIG. 3 is used, the flexibility of the fibers makes it possible to install the linear guide portion 110 along the road surface 101. The fiber that can be used in the linear guiding portion 110 shown in FIG. 14 is not limited to the aforementioned fibers 15a and 15b and it goes without saying that other fibers explained in Embodiment 1 can be also used.

The entry direction of the laser beam 13 to the fiber is preferably selected such that the laser beam 13 going out of the fiber is irradiated forward of the automobile 102. In this case the laser beam 13 can be irradiated even more easily with good directivity with respect to the driver of the automobile 102 driven in the direction of arrow 102d. As a result, the driver of the automobile 102 can recognize the linear guiding portion 110 as a line of a curved lane with good visibility even in the nighttime, and the driver can safely drive the automobile 102.

FIG. 15 is an explanatory drawing illustrating another configuration example of the linear guiding portion of the present embodiment. A linear guiding portion 110 shown in FIG. 15 is installed along a center line 112 of a road surface 101 or a side wall 113 inside a tunnel 111. The configuration of the fiber 15a and the fiber 15b shown in FIG. 3A and FIG. 3B is preferably used for the linear guiding portion 110 shown in FIG. 15.

In this case, the laser beam 13 can be irradiated even easier with good directivity. Therefore, the driver of the automobile 102 can recognize the linear guiding portion 110 as a lane line inside the tunnel with good visibility despite the fact that it is darker inside the tunnel than outside. As a result, the driver can safely drive the automobile 102 even in a dark tunnel. It goes without saying that other fibers (20, 30, 40, and the like) can be used for the linear guiding portion 110 shown in FIG. 15.

A configuration including the propagation portions A in which the laser beam 13 from the laser light source 14 propagates with low loss and the irradiation portions B that irradiate the laser beam 13 with good directivity by diffusion may be applied to the linear guiding portions 104 and 110 shown in FIG. 12 to FIG. 15.

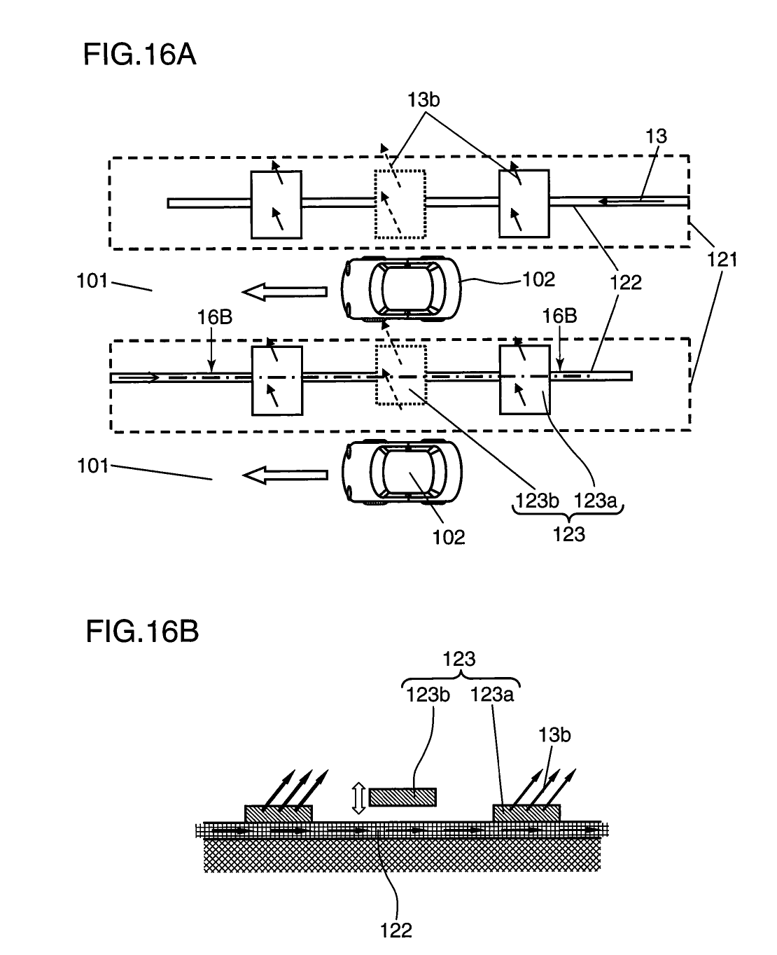

FIG. 16A is a plan view showing another configuration example of the guiding device of the present embodiment. FIG. 16B is a cross-sectional view taken along the 16B-16B line in FIG. 16A.

A guided device 130 shown in FIG. 16A is provided with two linear guiding portions 121 installed parallel to a lane along a road surface 101. A laser light source 14 and a power source 14c are disposed, similarly to the configuration described in Embodiment 1 and shown in FIG. 8, in an administrative building (not shown in the figure) or a control box (not shown in the figure) installed in a predetermined location by the road. A linear guiding portion 121 preferably includes a propagation line 122 in which a laser beam 13 propagates and a contact portion 123 that is provided so that it can be in contact with the surface of the fiber (propagation line) 122 on the exit side of the laser beam 13 and can take part of the laser beam 13 out of the fiber 122 to the outside.

The operation of the linear guiding portion 121 will be described below. The laser beam 13 entering the fiber 122 propagates in the fiber 122 and arrives directly below a contact portion 123a. The refractive index of the contact portion 123a is set slightly higher than that of the fiber 122. Part of the laser beam 13 enters from the fiber 122 to the contact portion 123a, and the remaining laser beam 13 continues propagating inside the fiber 122. When the contact portion 123a includes a diffusing material inside thereof, the laser beam that has entered the contact portion 123a is scattered forward. Even with a configuration that uses no diffusing material, for example, if a prism sheet is used as explained in Embodiment 1 with reference to FIG. 10A, the light diffused inside the contact portion 123a can be emitted with better directivity in a predetermined direction. Where the remaining laser beam 13 propagating inside the fiber 122 reaches the next contact portion 123a, this laser beam can exit the fiber in a similar manner.

The contact portion 123b of the present embodiment is normally not in contact with the fiber 122. However, for example, when the environment gets darker, the contact portion can be lowered and brought into contact with the fiber 122, if necessary, thereby making it possible to emit the laser beam 13b from the contact portion 123b in the same manner as in the case of the above-described contact portion 123a. Since the density of the location irradiated correspondingly to the lightness of the environment can be adjusted, the driver of the automobile 102 can recognize the linear guiding portion 121 along the road surface 101 with good visibility even in the nighttime. As a result, the driver can safely drive the automobile.

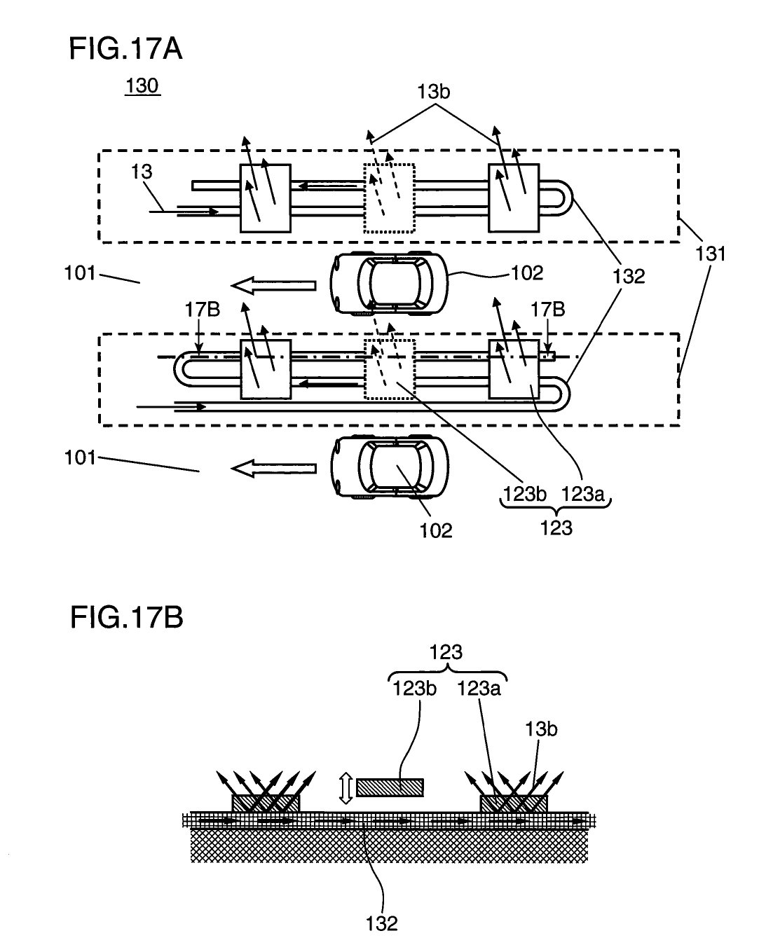

FIG. 17A is a plan view illustrating a configuration example of another guiding device of the present embodiment. FIG. 17B is a cross-sectional view taken along the 17B-17B line in FIG. 17A.

The guiding device shown in FIG. 17A and FIG. 17B has a configuration almost identical to that of the guiding device illustrated by FIG. 16A and FIG. 16B, the difference being in that a fiber 132 constituting a linear guiding portion 131 is folded back and disposed in parallel rows on and along the road surface 101. In the guiding device 130 shown in FIG. 17, similarly to the guiding device 120 shown in FIG. 16, the linear guiding portion 131 preferably has a propagation line 132 in which a laser beam 13 propagates and a contact portion 123 that is provided so that it can come into contact with an outgoing side of the laser beam 13 in the propagation line 132 and can take out a portion of the laser beam 13 from the fiber (propagation line) 132.

When the laser beam 13 that has entered the fiber 132 arrives directly below the contact portion 123a, part of the light enters the contact portion 123a and exits as a laser beam 13b to the outside.

In the linear guiding portion 131, the quantity of light of the laser beam 13 exiting from the extension surface of the laser light source 14 decreases with the distance from the laser light source, but in the linear guiding portion 132 that has been folded back and arranged in parallel rows as described hereinabove, the sites with a large distance and sites with a small distance from the laser light source 14 are parallel to each other and overlap each other, a substantially uniform irradiation intensity of the laser beam from each position along the road surface can be obtained, and visibility can be increased.

The laser beam 13 remaining inside the fiber 132 reaches the other contact portion 123a and is similarly taken out to the outside of the contact portion 132a. In this case, the fiber 132 is folded back when installed in the guiding device 130. Therefore, the laser beam 13 enters the same contact portion 123a again from the direction opposite the entrance direction into the contact portion 123a. Since the quantity of light in the laser beam 13 propagating inside the fiber 132 decreases each time the fiber 132 comes into contact with the contact portion 123a, the quantity of light emitted from the contact portion 123 upstream of the fiber 132 is larger than the quantity of light emitted from the contact portion 123 on the downstream side. In the guiding device 130, the installed fiber 132 is folded back. As a result, each contact portion comes twice into contact with fiber 132. As for the quantity of light exiting each contact portion, a substantially identical total quantity of light (before the folding and after the folding) can be caused to exit, regardless of the position of the contact portions 123 on the fiber 132. Further, the laser beam 13 from the fiber 132 enters the contact portion 123 from both sides, that is, from the left side and from the right side, as shown in FIG. 17. Therefore, when the contact portion 123 includes a diffusing material, the laser beam exiting from the contact portion 123 is scattered to the left and to the right, as shown in the figure. For example, when the guiding device is applied to a location where the automobiles 102 travel in the opposite directions on both sides of the linear guiding portion 131, such as a center line of a two-way traffic, the irradiation with good visibility can be ensured for the vehicle 102 traveling in either direction.

The operation of the contact portion 123b in a state without contact with the fiber 132 (usual state) is similar to that in the aforementioned guiding device 120 shown in FIG. 16 and the explanation thereof is herein omitted.

With the configuration shown in FIG. 17A and FIG. 17B, the laser beam 13b can be irradiated with a substantially uniform irradiation intensity from each position along the road surface 101. Therefore, the visibility can be improved. As a result, the driver of the automobile 102 can recognize with good visibility the linear guiding portion 131 installed along the road surface 101, and the driver can safely drive the automobile 102.

### Embodiment 3

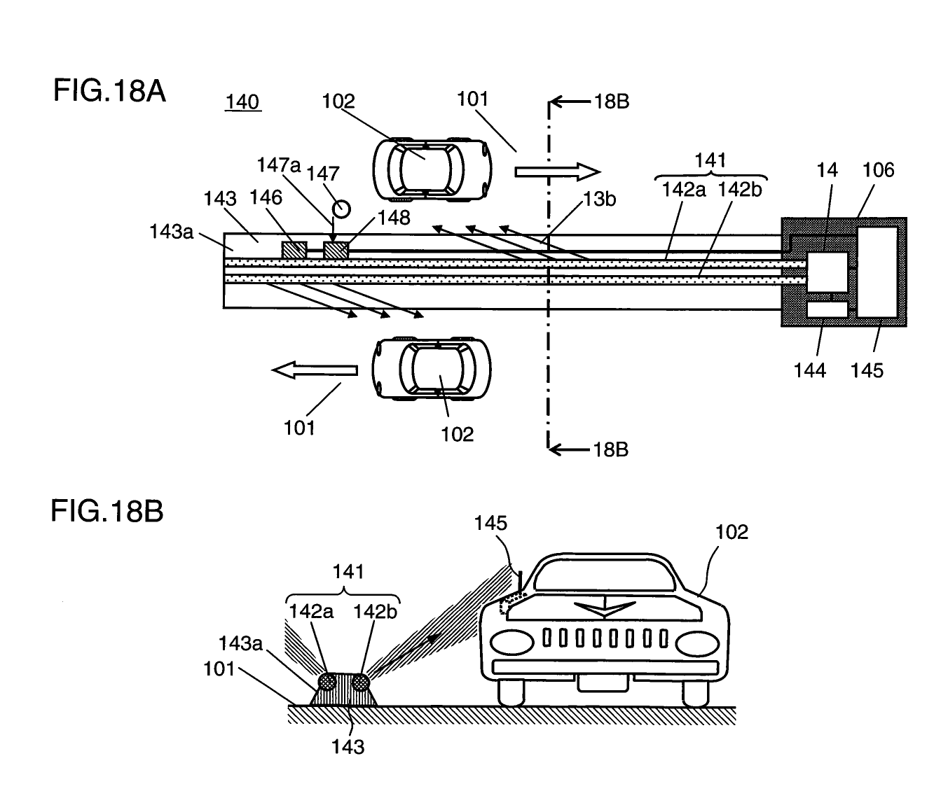

A guiding device according to yet another embodiment of the present invention will be described below with reference to FIG. 18A and FIG. 18B.

FIG. 18A is a plan view illustrating a schematic configuration of a guiding device 140 of the present embodiment. FIG. 18B is a cross-sectional view taken along the 18B-18B line in FIG. 18A.

As shown in FIG. 18A, the guiding device 140 of the present embodiment includes a laser light source 14 that emits a laser beam 13 and a linear guiding portion 141 composed of fibers 142a and 142b that guide the laser beam 13 and are disposed along a road surface 101 where an automobile (mobile body) 102 travels.

In this configuration, as shown in FIG. 18A and FIG. 18B, the fibers 142a and 142b are disposed on a top portion 143a of a side surface of a convex central separation zone 143 disposed on the road surface 101.

The fibers 142a and 142b may have a configuration including a diffusing material 15d, for example, as in the fibers 15a, 15b, and 15f shown in FIG. 3 of Embodiment 1. In this case, the laser beam 13b can be taken out to the outside of the fiber with good directivity in the predetermined direction by a mirror 15x, for example, as shown in FIG. 3D. The present embodiment is not limited to the above-described configuration and the laser beam 13 may be taken out to the outside of the fibers 142a and 142b, for example, by another method described in Embodiment 1.

The linear guiding portion 141 of the present embodiment has a function of guiding the automobile (mobile body) 102 by irradiating the laser beam 13 with good directivity in the direction along the road surface 101. Further, where the laser bean 13 enters the fiber from the front side of the automobile 102, the laser beam can be irradiated from the front side of the automobile 102, while the fiber remains disposed parallel to the road, as shown in FIG. 18A, due to the forward scattering in the fiber by the diffusing material 15d. With the fiber 17 shown in FIG. 5, the laser beam can be irradiated from the front side of the automobile 102, regardless of the direction in which the laser beam 13 enters the fiber, by appropriately selecting the angle of the mirror (or prism) 15p.

The above-described configuration makes it possible to realize the guiding device 140 that is simple in structure and installation and easy to maintain and excels in visibility. Further, with the guiding device 140, the laser beam 13 can be irradiated with good directivity along the road surface 101. Therefore, a linear guiding portion of excellent visibility that can be easily seen by the driver of the automobile 102 can be realized.

As shown in FIG. 18B, the guiding device 140 of the present embodiment has a configuration in which the fibers 142a and 142b are disposed on the top portion 143a of a side surface of the central separation zone 143. Therefore, the linear guiding portion 141 can be disposed in a compact manner in a position with good visibility. Further, since the guiding device 140 of the present embodiment excels in directivity, as described hereinabove, the desired region can be irradiated with low power consumption. Further, another fiber, light-guiding plate, or light-guiding sheet described in Embodiment 1 may be used instead of the fibers 142a and 142b.

Further, as shown in FIG. 18A and FIG. 18B, the guiding device 140 is further provided, in addition to the laser light source 14, with a modulation unit 144 that modulates the laser beam 13 and a control unit 145 that controls the modulation unit 144 and the laser light source 14 inside a control box 106. The laser beam 13 is modulated by the modulation unit 144 at a frequency of equal to or higher than 0.2 Hz and equal to or lower than 10 Hz.

In this case, viewable information such as traffic information can be provided to the driver under various circumstances by switching on the laser beam 13 at a speed that can be visually recognized by a person, in addition to the guiding function. When the laser beam 13 is modulated at a frequency equal to or below 0.1 Hz or above 10 Hz, the level recognizable by human eye is exceeded and the modulation rate is too high.

In another possible configuration that provides traffic information to the driver of the automobile 102, color of the laser beam 13 is changed, instead of modulating the laser beam 13. For example, when there is highway traffic jam information and the distance from the present location to the jam zone and the length of the jam zone are represented by switch-on frequency and color (when there is no jam, the color is green and the color changes from yellow to red with the increase in the jam length), the driver can intuitively obtain jam information passively, without receiving the jam information actively via radio or the like, in a real time.

In another possible configuration, the laser beam 13 may be high-speed modulated by the modulation unit 144 and sent to the automobile 102 to transmit running information. In this case, by providing the automobile 102 with an optical receiver (signal receiver) 145 that receives the modulated laser beam 13, it is possible to receive the modulated laser beam 13 and use the running information converted into electric signals.

With the above-described configuration, the laser beam 13 can be irradiated with good directivity along the road surface 101 and the driver can be alerted with good visibility. At the same time, various types of information using the laser bean 13 as a carrier can be transmitted as modulated signals and received by the receiver 145 installed on the automobile 102. As a result, information relating to the road in the area where the automobile 102 is located, such as traffic information, can be received in a real time mode and therefore convenience for the driver can be improved.

Further, in the present embodiment, running information and traffic information are explained as examples of the transmitted and received information, but the information that is the object of transmission and reception in the present embodiment is not limited to the aforementioned types of information and may include meteorological information and guidance information for neighboring areas. Further, the medium receiving the information is not limited to automobiles and it goes without saying that the above-described configuration is applicable to the case in which a person receives guidance information via a portable terminal or the like.

Further, as shown in FIG. 18A, it is preferred that the linear guiding portion 141 be provided with an optical sensor 146 that detects lightness of the road surface 101.

In this case, the external light irradiating the road surface 101 or the central separation zone 143 is detected by the optical sensor 146. The external light detected by the optical sensor 146 is converted into an electric signal and sent to the control unit 145. The control unit 145 adjusts and controls the intensity of the laser beam 13 on the basis of the inputted electric signal. The control unit 145 thus adjusts and controls the intensity or color of the laser beam 13, for example, correspondingly to the surrounding lightness. As a result, the laser beam 13 that can be optimally recognized by the driver can be irradiated at a necessary and sufficient power level. Therefore, power consumption can be reduced.

The present linear guiding portion 141 is preferably provided with an infrared radiation sensor 148 as a human body detection sensor that detects the presence of a pedestrian (person) 147.

In the configuration provided with an infrared radiation sensor as a human body detection sensor, where a person 147 approaches an infrared radiation sensor 148, the quantity of infrared radiation 147a in the vicinity of the sensor 148 increases. As a result, the infrared radiation sensor 148 can detect the presence of the person 147 by detecting the increase in the quantity of the infrared radiation 147a. When such a configuration is applied, for example, to a road or a parking area, where the person 147 enters the area close to an automobile (mobile body) 102, the presence of the person is immediately detected and the driver is notified thereof. In addition, the guiding device 140 with increased safety can be realized. The human body detection sensor is not limited to the infrared radiation sensor 148 and, for example, a pyroelectric infrared radiation sensor may be used.

In the present embodiment, similarly to the above-described embodiments, a configuration may be used in which the laser light source 14 includes an RGB beam source composed at least of an R beam source 14R emitting an R beam 13R, a G beam source 14G emitting an G beam 13G, and a B beam source 14B emitting an B beam 13B. With such a configuration, the laser beam 13 of deep color that excels in color reproducibility can be irradiated. As a result, the visibility of the guiding device can be further improved.

Similarly to the above-described embodiments, in the laser light source of the present embodiment, the liner guiding portion may be constituted by a propagation portion A in which the laser beam 13 from the laser light source 14 propagates with low loss and an irradiation portion B that irradiates the laser beam 13 with good directivity by scattering. With such a configuration, the laser beams 13, 54 can be used with good efficiency and therefore, the laser light source 14 can be operated at a low level of power consumption.

Similarly to the above-described embodiments, the laser light source of the present embodiment may be a beam source including no RGB beam source. In this case, it is preferred that the laser light source 14 include at least the G beam source 14G. A high-output SHG laser excited by a semiconductor laser and outputting the G beam 13G with a wavelength close to 535 nm is preferably used as the G beam source 14G. In this case, the green laser beam 13 with high visibility to human eyes can be used. Therefore, a linear guiding portion with high visibility can be provided at a low level of power consumption.

The green laser beam 13 features a high photoelectric conversion efficiency and a narrow half-width of wavelength spectrum. Therefore, for example, in comparison with the case in which the same effect is obtained by using light from a green LED, the green laser beam 13 makes it possible to realize a high visibility at about one tenth of the power.

### Embodiment 4

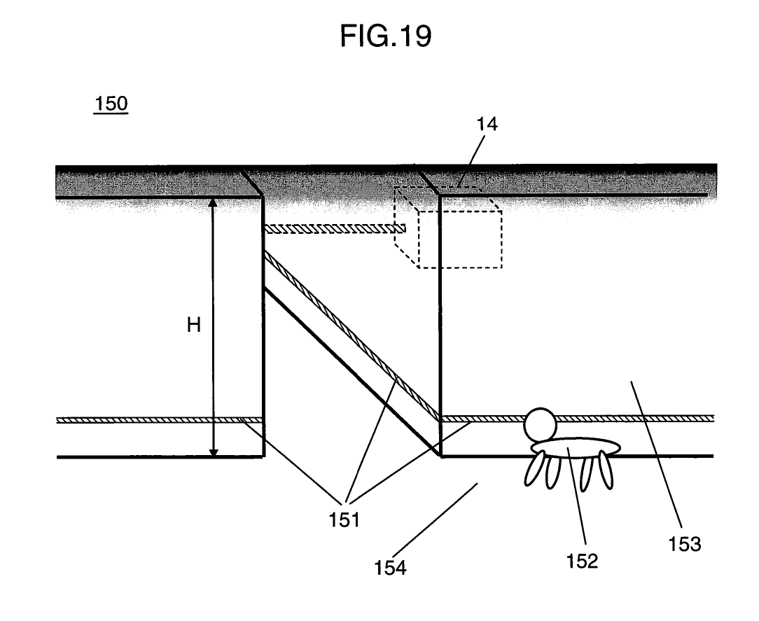

A guiding device of yet another embodiment of the present invention will be explained below with reference to FIG. 19.

As shown in FIG. 19, a guiding device 150 of the present embodiment includes a laser light source 14 and a linear guiding portion 151. The linear guiding portion 151 of the present embodiment is suitable, for example, as a guidance lamp used during an emergency such as fire in a building such as an office of a mansion.

In the present embodiment, the laser light source 14 is controlled in a fireproof shelter (not shown in the figure) in a separate room and the light is guided by a fiber.

In the case of fire, hazardous fumes and gases (carbon dioxide and the like) are accumulated close to the ceiling, and therefore when escaping to the outside of the building, people are usually assumed to crawl out close to the path surface of the passage 154.

Accordingly, in the present embodiment, the linear guiding portion 151 is installed in a lower half of the side surface 153 constituting the internal passage at a height equal to or less than half of the height H. As a result, the passage can be made clearly visible, for example, to people who try to escape the fire by crawling out. As a result, the people can be guided so as to escape rapidly to the outside. Therefore, the possibility of emergency escape is increased. Thus, the guiding device 150 of the present embodiment can be advantageously used as a guidance lamp of the indoor passage.

It is preferred that glass such as quartz glass be used as a material for the linear guiding portion 151.

In this case, since glass excels in heat resistance and can withstand a high temperature of equal to or higher than 1000° C., where the laser light source 14 is placed in a heat-resistant shelter in a separate room, as described hereinabove, the passage can be indicated without trouble even in the case of fire. Therefore, the laser light source can be advantageously used as an emergency guidance lamp.

Further, since the fiber itself is extremely thin and takes absolutely no place, the fiber does not narrow the evacuation passage.

A configuration with full color illumination such as shown in FIG. 4 may be used for the above-described configuration shown in FIG. 19. In this case, it is possible, for example, to link the linear guide portions to temperature sensors provided inside the rooms and switch on red emission in a linear guiding portion installed in a zone that offers no escape, such as the vicinity of the section in which fire has occurred, and allocate green irradiation to evacuation passages that are safe and provide the shortest escape route on the basis of information from temperature sensors installed in each room, thereby making it possible to provide information to a person 152 about the escape route that has to be followed. As a result, the person 152 who has to be evacuated can be accurately guided and evacuated with better safety, thereby enabling safe escape to the outside.

The linear guiding portion 151 in the present configuration may be also installed on a road surface 154 of the passage, rather than on the side surface 153.

The diffusing material 15d or diffusing material 35 described in the embodiments hereinabove may be a transparent substance with a refractive index different from that of the substance surrounding the diffusing material, or a fluorescent material may be used instead of the diffusing material 15d or diffusing material 35. The fluorescent material is not limited to the substance described in Embodiment 2, provided that the light of desired color is emitted.

### Embodiment 5

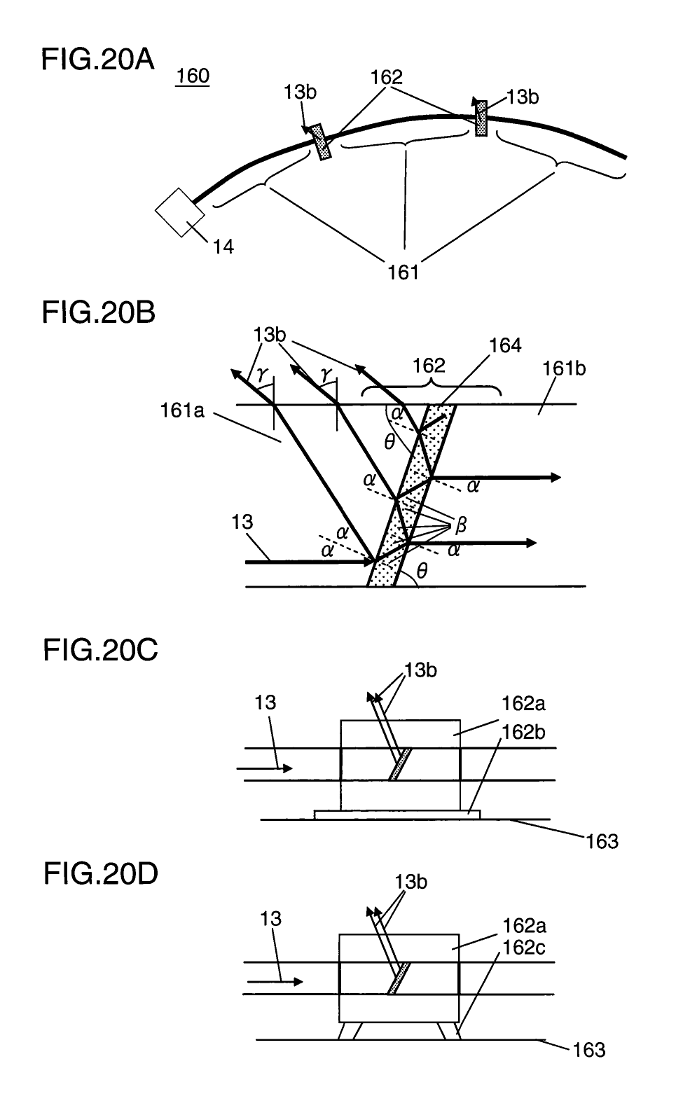

The guiding device of yet another embodiment of the present embodiment will be described below with reference to FIG. 20A to FIG. 20D.

FIG. 20A to FIG. 20D are schematic configuration diagrams of the guiding device 160 of the present embodiment. As shown in FIG. 20A, the guiding device 160 includes a laser light source 14 emitting a laser beam 13, a plurality of unit-length fibers 161 having a predetermined unit length, and joining portions that join together the adjacent unit-length fibers 161. In this configuration the laser beam 13b is taken out from the joining portions 162. FIG. 20B shows an example of a configuration illustrating how the laser beam 13b is taken out from the joining portion 162.

In FIG. 20B, the end surfaces of the unit-length fibers 161 that are to be joined (in FIG. 20B, the outgoing side and incoming side of the laser beam 13b are distinguished from each other and denoted by reference symbols 161a and 161b, respectively) are cut at the same angle θ, the cut end surfaces are disposed so as to be parallel to each other, and the gap therebetween is filled with a joining member 164.

Part of the laser beam 13 falling at an angle α to the normal to the end surface of the unit-length fiber 161a is irradiated at an angle α to the normal to the end surface. The remaining incoming laser beam 13 is transmitted via the end surface at an angle β obeying the Snell's law and enters the end surface of the unit-length fiber 161b. Likewise, part of the laser beam 13 falling at an angle β on the end surface of the unit-length fiber 161b is transmitted at an angle α to the normal to the end surface. The remaining part of the incident laser beam 13 is reflected at an angle β, reaches the end surface of the unit-length fiber 161a, and part of the beam is further transmitted at an angle α inside the unit-length fiber 161a. Similar reflection is thereafter repeated between the end surfaces of the unit-length fibers 161a and 161b. All of the laser beams that underwent such multiple reflections at the end surfaces of the unit-length fibers 161a and 161b are irradiated as the laser beams 13b in the direction at the same angle γ. More specifically, for example, the fibers (refractive index=1.5) cut at an angle θ=45° are joined by the joining member 164 (refractive index 1.7), and the laser beam falling horizontally (that is, α=45°) is irradiated directly upward from the fiber (that is, γ=0°). In this case, the laser beam 13b taken to the outside of the fiber constitutes about 0.8% of the incoming laser beam 13.

The linear guiding portion of the present embodiment can take out the laser beam from each joining portion. Therefore, light-emitting portions can be readily provided with a predetermine spacing (that is, for each length of the unit-length fiber). Further, with the configuration shown in FIG. 20B, the laser beam can be taken out with good directivity to the outside of the fiber. Therefore, the configuration with excellent visibility can be obtained.

It goes without saying that the above-described configuration is not limited to one example, and the angle θ of the end surfaces, angle α of incidence, and refractive index can be appropriately selected. Further, the refractive index of the joining member 164 may be made zero (that is, the gap between the unit-length fibers is not filled).

The unit length of the fibers is preferably, for example, 1 m. In this case, equidistant regular irradiation is possible and power consumption can be reduced, while conducting effective irradiation. Further, since the operations of cutting the fibers and processing the end surfaces can be conducted for large quantities in advance at a plant, inexpensive guide can be provided. The unit length is merely an example, and it goes without saying that the fiber length can be changed to any length as required by the installation site.

The guiding device 160 may also have a configuration shown in FIG. 20C. Thus, a joining portion 162 may be fixed in a position in which the laser beam 13b exits at a predetermined angle of the laser beam 13b with respect to a ground surface 163. In the present embodiment, as shown in FIG. 20C, the joining portion 162 is fixed to the ground surface 163 by a holding portion 162a and a fixing stand 162b. For example, in a case in which the unit-length fibers 161a, 161b shown in FIG. 20B are used, the end surfaces should be parallel to each other, as mentioned hereinabove, in order to take out the laser beam 13b in the predetermined direction with good directivity. Therefore, by using the holding portion 162a and fixing so that the end surfaces are parallel to teach other, the laser beam 13b can be taken out with good directivity. Further, where fixing to the ground surface 163 is made in a state in which the fixing stand 162b is fixed to the holding portion 162a with a predetermined orientation, the fixing can be performed so that the laser beam 13b exits in a predetermined direction with respect to the ground surface 163 where the installation is made. In this case, the orientations of laser beams exiting from joining positions can be easily matched.

In the configuration shown in FIG. 20D, fixing protrusions 162c may be used instead of the fixing stand 162b, in the same manner as in the configuration shown in FIG. 20B. However, the present embodiment is not limited to the above-described method and configuration and other methods and configurations capable of fixing the orientation of the fiber may be also used.

In the above-described embodiments, quartz and resin are considered as materials constituting the fiber core and cladding, but it goes without saying that the materials can be freely selected according to the environment in which the fibers will be used, length, and application. When the fibers are to be simply used outdoors for a long time, the use of quartz fibers that excel in endurance can be considered, and when curved fibers are installed, the use of resin fibers such as acrylic or polycarbonate fibers that excel in flexibility even when they have a large thickness can be considered, but these fibers are not limiting and appropriate fibers such as fluoropolymer resin, deuterated polymer, or polystyrene fibers can be freely selected. A combination of quartz as a core and a resin as a cladding may be also used.

As described above, the guiding device that guides a mobile body by light according to one aspect of the present invention includes a laser light source that emits a laser beam, and a linear guiding portion that propagates the laser beam and is extended in a guiding direction on a road surface on which the mobile body travels, wherein the linear guiding portion irradiates the laser beam with directivity in the guiding direction from a surface where the linear guiding portion extends, while propagating the laser beam.

With such a configuration, the laser beam emitted from the laser light source is irradiated with directivity in the guiding direction from an extension surface thereof, while propagating the laser beam in the linear guiding portion extended on the road surface. Thus, the linear guiding portion has both the function of propagating the laser beam emitted from the laser light source and the function of irradiating and guiding the laser beam from the extension surface. The linear guiding portion of such a configuration is significantly different from a typical optical fiber as described below.

Thus, a typical optical fiber has only a function of propagating the light, and in the typical optical fiber, the propagating light is irradiated only from the distal end of the optical fiber. Therefore, where a device for guiding by light is to be realized by using typical optical fibers, a large number of optical fibers should be used and distal ends of the large number of optical fibers should be arranged as shown in Patent Document 2.

By contrast, as described above, the linear guiding portion of the present guiding device takes out and irradiates the laser beam from the extension surface, while propagating the laser beam. Therefore, the desired laser beam can be taken out over a wide range from the extension surface of one linear guiding portion. Thus, with the present guiding device, guiding by light can be realized easily and over a wide range by extending the linear guiding portion connected to the laser light source. As a result, it is possible to realize a low-cost guiding device that is simple in structure and installation and easy to maintain. Further, the present guiding device irradiates a laser beam with good directivity along the guiding direction. Therefore, the laser beam is easily seen, for example, by a driver of a mobile body and excels in visibility.

The laser light source is preferably installed at the road surface or below the road surface.

Although the laser beam device is disposed outside the road surface or below the road surface, as described hereinabove, guiding by light can be easily realized over a wide range by extending the linear guiding portion. Therefore, the laser light source can be provided, for example, inside a room of an administrative building outside the road surface or in a protective chamber below the road surface, and the laser light source can be easily and adequately protected from water, atmosphere, and sunlight. As a result, the service life of the entire guiding device can be extended.

It is preferred that the linear guiding portion include a fiber having a core and a cladding, and at least one of the core and the cladding include a diffusing material.

By using the fiber including a diffusing material in at least either of the core and the cladding, it is possible to realize easily a linear guiding portion. Further, by adequately designing the arrangement or density of the diffusing material inside the fiber in such a configuration, it is possible to irradiate the desired laser beam easily and with good directivity.

The linear guiding portion is preferably provided with a plurality of mirrors or prisms that cause the laser beam to exit from the surface, where the linear guiding portion extends, to the outside.

By so using a plurality of mirrors or prisms, it is possible to irradiate the laser beam easily and with good directivity in the desired direction.

It is preferred that the above-described configuration further include a light-guiding plate that is connected to a distal end portion of the linear guiding portion and irradiates the laser beam as a plane-like beam.

In this case, the laser beam can be irradiated as a plane-like beam and therefore the laser beam can be irradiated with a certain width on the road surface. As a result, visibility can be further increased.

The linear guiding portion preferably includes a propagation line in which the laser beam propagates, and a contact portion that is provided to be capable of coming into contact with a surface of the propagation line on an exit side of the laser beam and takes out part of the laser beam from the propagation line to the outside.

With such a configuration, by adequately designing the arrangement of the contact portion that is brought into contact with the propagation line, it is possible to take the laser beam out with good efficiency in a desired position. For example, the laser beam can be taken out periodically.

The linear guiding portion is preferably folded back along the road surface to obtain a parallel arrangement.

In the linear guiding portion, the quantity of laser beam exiting from the extension surface of the linear guiding portion decreases with the distance from the laser light source, but in the linear guiding portion that is folded back to obtain a parallel arrangement, the portion that is close to the laser light source and the portion that is far from the laser light source are parallel to each other and stacked, thereby making it possible to obtain an almost uniform irradiation intensity of the laser beam from each position along the road surface and increase visibility.

The linear guiding portion is preferably disposed on a top portion of a side surface of a convex central separation zone provided on the road surface.

In this case, the guiding device can be disposed in a compact manner in a location with good visibility.

The linear guiding portion is preferably disposed in a lower-half region of a side surface constituting an indoor passage as the road surface.

In this case, a guiding device suitable as a guidance lamp for indoor passages can be realized.

The linear guiding portion preferably includes a plurality of branch fibers arranged to irradiate the laser beam as a plane-like beam.

As a result, plane-like irradiation of a laser beam can be realized with a simple configuration and visibility can be further increased.

It is preferred that a mirror be disposed around the linear guiding portion and the laser beam exiting the linear guiding portion be reflected by the mirror.

The mirror is preferably a paraboloidal mirror.

It is preferred that the linear guiding portion include a fiber in which the laser beam propagates, and the fiber be curved in a position in which the laser beam is taken out.

The curving diameter of the fiber in the position in which the laser beam is taken out preferably decreases towards the downstream side of the fiber.

As a result, the total reflection condition is easily exceeded inside the fiber at the downstream side thereof and a laser beam can be irradiated with a uniform quantity of light, regardless of the distance from the laser light source.

It is preferred that the linear guiding portion include a fiber in which the laser beam propagates, the fiber have a cladding and a hollow portion surrounded by the cladding, and a transparent liquid including a fluorescent material or a diffusing material be injected into the hollow portion.

In such a configuration, it is preferred that a plurality of transparent liquids that are not mutually miscible be injected into the hollow portion.

The linear guiding portion preferably includes a taper fiber in which a cross section diameter changes with the distance from the laser light source.

The linear guiding portion preferably has an annular structure such that an end portion thereof is in contact with a laser beam entry portion.

The linear guiding portion is preferably a taper fiber in which a cross section diameter changes with the distance from the laser light source.

The linear guiding portion preferably includes a fiber having a core and a cladding, and a refractive index of the core is lower than a refractive index of the cladding.

In this case, a laser beam can be easily taken out over a long region with a uniform distribution.

The linear guiding portion is preferably formed by joining a plurality of fibers having a predetermined length, and the laser beam is taken out from the joining portions in which the plurality of fibers are joined.

In this case, the laser beam can be taken out from the joining portions. Therefore, light-emitting portions can be easily provided for each predetermined distance. Further, since the laser beam can be taken with good directivity to the outside of the fiber, a configuration with excellent visibility can be obtained.

The above-described configuration preferably further includes a fixing portion that fixes the joining portion according to a predetermined orientation with respect to the road surface.

The guiding device according to another aspect of the present invention includes: a laser light source that emits a laser beam; a fiber that guides the laser beam entering thereto; and a light-guiding sheet that irradiates the laser beam guided by the fiber as a two-dimensional beam, and the light-guiding sheet is processed into a mesh-like shape.

With such a configuration, since a light-guiding sheet is used that has been processed into a mesh-like shape, even if part of the propagation path is cut, the laser beam from other locations bypasses the cut portion and therefore the laser beam can be caused to exit the propagation path downstream of the cutting position. As a result, a highly reliable guiding device of a simple configuration from which the laser beam exits with good directivity over a wide range can be realized.

It is preferred that the above-described configuration further include a control unit that controls the laser light source and changes an emission frequency or color of the laser beam, wherein the control unit provides information to a driver of the mobile body by modulating the emission frequency of the laser beam within a range from 0.2 Hz to 10 Hz or by changing the color of the laser beam.

In this case, in addition to the guiding function, it is possible to alert the driver by providing viewable information such as traffic information.

It is preferred that the above-described configuration further include a modulation unit that modulates the laser beam, the modulation unit modulating the laser beam as a carrier and transmitting information to the mobile body.

With the above-described configuration, it is possible to use the laser beam as a carrier, carry various kinds of information as modulation signals thereupon, and send the modulated laser beam to the mobile body. As a result, where the laser beam is received by a receiver installed at the mobile body, information relating to the road in the area where the mobile body is located, such as traffic information, can be received in a real time mode. Therefore, convenience for the driver can be improved.

It is preferred that the above-described configuration further include an optical sensor that detects a lightness of the road surface, and a control unit that controls the laser light source on the basis of a detection result of the optical sensor.

In this case, by changing the intensity or color of the laser beam in response to the ambient lightness, it is possible to irradiate, with sufficient and necessary power, the layer beam that can be optimally viewed by the driver.

It is preferred that the linear guiding portion in the above-described configuration further include a human body detection sensor that detects the presence of a pedestrian, and a control unit that controls the laser light source on the basis of a detection result of the human body detection sensor.

In this case, a person present close to the mobile body, for example in a parking lot, can be immediately detected and the driver can be notified thereof, thereby making it possible to realize a guiding device with even higher safety.

Industrial Applicability

The guiding device in accordance with the present invention uses fiber configuration and arrangement on a road surface and ensures directivity of laser beam take-out from the fiber by optical means. As a result, the guiding device can be advantageously used in a road display device that is simple in structure and installation and easy to maintain and excels in visibility.

Further, by using the speckle noise or color of laser beams, it is possible to increase visibility at a necessary and sufficient power. As a result, operation with low power consumption is enabled, a large volume of information can be provided to the mobile body driver in a real time mode, and the mobile body can be conveniently operated.

Specific embodiments and examples presented in the detailed description of the invention merely serve to clarify the technical contents of the invention and are not to be considered in a limiting sense. Thus, the present invention can be practiced with various modifications within the spirit of the invention and scope of the appended claims.

1-27. (canceled)

28. A guiding device that guides a mobile body by light, comprising:
a laser light source that emits a laser beam, and
a linear guiding portion that propagates the laser beam and is extended in a guiding direction on a road surface on which the mobile body travels, wherein
the linear guiding portion irradiates the laser beam with directivity in the guiding direction from a surface where the linear guiding portion extends, while propagating the laser beam,
the linear guiding portion includes a taper fiber in which the cross section diameter varies depending on a distance from the laser light source, and
the laser beam enters the taper fiber from a side having a large cross section diameter.

29. The guiding device according to claim 28, wherein
the laser light source is disposed outside the road surface or below the road surface.

30. The guiding device according to claim 28, wherein
the linear guiding portion includes a fiber having a core and a cladding, and
at least one of the core and the cladding includes a diffusing material.

31. The guiding device according to claim 28, wherein the linear guiding portion includes a fiber having a core and a cladding, and a refractive index of the core is lower than a refractive index of the cladding.

32. The guiding device according to claim 28, wherein a taper angle of the tapered fiber varies with a distance from the laser light source.

33. The guiding device according to claim 28, wherein
the linear guiding portion includes a propagation portion and an irradiation portion,
the propagation portion is a fiber that is not tapered, and
the irradiation portion is the tapered fiber.

34. The guiding device according to claim 28, wherein
the linear guiding portion has an annular structure, with an end portion thereof being connected to an entry portion of the laser beam.

35. The guiding device according to claim 28, further comprising
a control unit that controls the laser light source and changes an emission frequency or color of the laser beam, wherein
the control unit provides information to a driver of the mobile body by modulating the emission frequency of the laser beam within a range from 0.2 Hz to 10 Hz or by changing the color of the laser beam.

36. The guiding device according to claim 28, further comprising
a modulation unit that modulates the laser beam,
the modulation unit modulating the laser beam as a carrier and transmitting information to the mobile body.

37. The guiding device according to claim 28, further comprising:
an optical sensor that detects a lightness of the road surface; and
a control unit that controls the laser light source on the basis of a detection result of the human body detection sensor.

38. The guiding device according to claim 28,
the linear guiding portion further comprises:
a human body detection sensor that detects the presence of a pedestrian; and
a control unit that controls the laser light source on the basis of a detection result of the human body detection sensor.
